(19) United States
(12) Patent Application Publication
(10) Pub. No.: US 2006/0259282 A1
(43) Pub. Date: Nov. 16, 2006

(54) Deterministic computation of radiation transport for radiotherapy dose calculations and scatter correction for image reconstruction

(76) Inventors: Gregory A. Failla, Gig Harbor, WA (US); John M. McGhee, Hollis, NH (US); Todd A. Wareing, Gig Harbor, WA (US); Douglas A. Barnett, Pattersonville, NY (US)

Correspondence Address: OLYMPIC PATENT WORKS PLLC, P.O. BOX 4277, SEATTLE, WA, 98104, US

(21) Appl. No.: 11/273,596

(22) Filed: Nov. 14, 2005

Related U.S. Application Data
(63) Continuation-in-part of application No. 10/910,239, filed on Aug. 2, 2004.
Application No. 10/910,239 is a continuation-in-part of application No. 10/801,506, filed on Mar. 15, 2004, now abandoned.
(60) Provisional application No. 60/454,768, filed on Mar. 14, 2003.
(60) Provisional application No. 60/491,135, filed on Jul. 30, 2003.
(60) Provisional application No. 60/505,643, filed on Sep. 24, 2003.

(51) Int. Cl. G06F 17/10; G06F 7/60

(52) U.S. Cl. 703/2

(57) ABSTRACT

One method embodiment of the present invention is a process for using deterministic methods to calculate dose distributions resulting from radiotherapy treatments, diagnostic imaging, or industrial sterilization, and for calculating scatter corrections used for image reconstruction. In one embodiment of the present invention, the method provides a means for constructing a deterministic computational grid from an acquired 3-D image representation, transport of an external radiation source through field shaping devices and into the computational grid, calculation of the radiation scatter and/or delivered dose in the computational grid, and subsequent transport of the scattered radiation to detectors external to the computational grid. In another embodiment of the present invention, the method includes a process, by solving the adjoint form of the transport equation, which can enable patient dose responses to be calculated independently of treatment parameters and prior to treatment planning, enabling patient dose fields to be accurately reconstructed during treatment planning and verification.

### CROSS REFERENCE TO RELATED APPLICATIONS

This application is a continuation-in-part of application Ser. No. 10/910,239, filed Aug. 2, 2004, which is a continuation-in-part of application Ser. No. 10/801,506, filed Mar. 15, 2004, which claims the benefit of provisional Patent Application Nos. 60/454,768, filed Mar. 14, 2003, 60/491,135 filed Jul. 30, 2003 and 60/505,643, filed Sep. 24, 2003.

### TECHNICAL FIELD

The present invention is related to computer simulations of radiation transport and, in particular, computational methods and systems for calculating radiation doses delivered to anatomical tissues and structures from radiotherapy treatments, sterilization processes, or imaging modalities, and for the prediction of scattered radiation related to image reconstruction, for medical and industrial applications.

### BACKGROUND OF THE INVENTION

Radiation transport plays a critical role in many aspects of radiotherapy and medical imaging. In radiotherapy, it is necessary to accurately calculate radiation dose distributions to planning treatment volumes (PTV), critical structures, and organs at risk (OAR). Dose calculations are recognized as an important step in radiotherapy treatment planning and verification, and one which is often repeated numerous times in the development and verification of a single patient plan. Modalities include external beam radiotherapy, brachytherapy, and targeted radionuclide therapies. Multiple variations exist for each of these treatments. For example, photons, electrons, neutrons, protons, and heavy ions can all be delivered through external beams. In addition, many variations exist in beam delivery methods, including 3D conformal radiotherapy (“3D-CRT”), intensity modulated radiotherapy (“IMRT”), stereotactic radiosurgery (“SRS”), and Tomotherapy®, a trademark of Tomotherapy, Inc. Brachytherapy treatments include photon, electron and neutron sources, and can use a variety of applicators and other delivery mechanisms.

Accurate dose calculations also play a role in medical imaging, where it may be desired to calculate patient doses from radiation delivering imaging modes such as computed tomography (CT), positron emission tomography (PET), and emission computed tomography (ECT) methods such as single photon emission computed tomography (SPECT).

Similarly, dose calculations may also be of benefit to determine local dose distributions for components in industrial sterilization applications.

For industrial and medical imaging, scattered radiation can substantially limit the quality of a reconstructed image. In such cases, accurate computational predictions of the scattered component reaching detectors can improve image quality. This is especially true in modalities such as volumetric CT imaging (VCT), where the ratio of scattered-to-primary radiation at detectors may be relatively high.

The physical models that describe radiation transport through anatomical structures are highly complex, and accurate methods such as Monte Carlo can be computationally prohibitive. As a result, most clinically employed approaches are based on simplifications which limit their accuracy and/or scope of applicability. For radiotherapy, this may translate to suboptimal treatment plans, due to uncertainties in the delivered dose. For imaging, a reduced reconstructed image quality may result.

Radiotherapy treatment planning commonly involves generating a three-dimensional anatomical image through computed tomography (CT) or another image modality such as magnetic resonance imaging (MRI). The data obtained from these methods are generally reviewed and modified by a physician to identify and segment anatomical regions of interest (treatment planning volume, critical structures, etc.) and to make any additional preparations for radiotherapy treatment planning computations. The data output from this process is often in an anatomical image format such as DICOM or DICOM-RT. A medical physicist will then use this data, with physician input, to generate a radiotherapy treatment plan. During treatment plan optimization and verification, radiation dose calculations are carried out on a hardware platform (e.g., a computer, server, workstation or similar hardware).

Current methods employed for radiotherapy and imaging radiation transport computations can be broadly grouped into 3 categories: Monte Carlo, deterministic, and analytic. Monte Carlo methods stochastically predict particle transport through media by tracking a statistically significant number of particles. While Monte Carlo methods are recognized as highly accurate, simulations are time consuming, limiting their effectiveness for clinical imaging and radiotherapy applications. Deterministic, in this context, refers to methods which deterministically solve the Linear Boltzmann Transport Equation (LBTE), the governing equation of radiation transport. Examples of such approaches include discrete-ordinates, spherical-harmonics, and characteristic methods. Historically, these methods are most well-known in the nuclear industry, where they have been applied for applications such as radiation shielding. However, the use of deterministic solvers for radiotherapy and imaging applications has been almost non-existent, except for limited research in radiotherapy delivery modes such as neutron capture therapy and brachytherapy. This can be attributed to several factors, including limitations in transporting highly collimated radiation sources, and the computational overhead associated with solving a large number of elements in three dimensions. Analytic methods, in this context, refer to simplified models which approximate models to simulate radiation transport effects. Examples of which include pencil beam or convolution algorithms. Due to their relative computational efficiency, such approaches are widely used in radiotherapy and imaging. However, their accuracy is limited.

A need exists for accurate, generally applicable and computationally efficient radiation transport methods in radiotherapy and imaging applications.

### SUMMARY OF THE PRESENT INVENTION

One method embodiment of the present invention is a process for using deterministic methods to calculate dose distributions resulting from radiotherapy treatments, diagnostic imaging, or industrial sterilization, and for calculating scatter corrections used for image reconstruction. In one embodiment of the present invention, the method provides a means for constructing a deterministic computational grid from an acquired 3-D image representation, transport of an external radiation source through field shaping devices and into the computational grid, calculation of the radiation scatter and/or delivered dose in the computational grid, and subsequent transport of the scattered radiation to detectors external to the computational grid. In another embodiment of the present invention, the method includes a process, by solving the adjoint form of the transport equation, which can enable patient dose responses to be calculated independently of treatment parameters and prior to treatment planning, enabling patient dose fields to be accurately reconstructed during treatment planning and verification.

### FIGURES

FIG. 1 shows a diagram of a collimated CT image source passing through an anatomical region to a detector array.

FIG. 2 shows a diagram of a single beam for an external beam radiotherapy treatment.

FIG. 3 shows a computational grid of an anatomical region

FIG. 4 shows a comparison between image voxels and computational grid elements.

FIG. 5 shows a comparison between primary and secondary computational grid elements, and image voxels.

FIG. 6 shows an example of body-fitted modeling of contoured structures using arbitrary 4-noded elements.

FIG. 7 shows examples of finite element shape functions that can applied to Cartesian elements.

FIG. 8 shows relationships between acquired image voxels, homogenized material regions, and the computational grid elements.

FIG. 9 illustrates the ray tracing of the primary flux for both CT imaging and radiotherapy.

FIG. 10 illustrates the ray tracing of the primary flux to the unknown flux locations of the patient grid elements.

FIG. 11 illustrates ray tracing of the primary flux through field shaping devices up to a phase space description (PSD).

FIG. 12 illustrates potential locations of upper and lower PSDs.

FIG. 13 illustrates a transport grid used to transport scattered radiation through field shaping devices.

FIG. 14 illustrates ray tracing from the upper PSD to the lower PSD.

FIG. 15 illustrates ray tracing from the upper PSD to elements in the transport grid in the field shaping devices.

FIG. 16 illustrates ray tracing from the lower PSD into the patient grid.

FIG. 17 illustrates the transport of scattered radiation from the lower PSD into the patient grid.

FIG. 18 illustrates an imaging process using the last-collided-flux method.

FIG. 19 illustrates contoured structures and corresponding elements where adjoint sources are applied.

FIG. 20 illustrates the use of the last-collided-flux method to transport an adjoint scattering source to the PSDs.

FIG. 21 illustrates element adaptation based on the primary flux for a single beam.

FIG. 22 illustrates element adaptation based on the primary flux for converging beams where only elements in the high dose regions are adapted.

FIG. 23 illustrates the suppression of elements not located within, and adjacent to, the primary beam paths.

### DETAILED DESCRIPTION OF THE INVENTION

One method embodiment of the present invention is a process for using deterministic methods to calculate dose distributions resulting from radiotherapy treatments, diagnostic imaging, industrial imaging, and sterilization, and for calculating scattered radiation for the purposes of image reconstruction.

In one embodiment of the present invention, analytic ray tracing can be used to transport the primary, or uncollided, energy dependent flux from a source location into a computational grid, and from this determine the first-scattered distributed source for a deterministic transport calculation. In this context, transport calculation refers to a deterministic solution method which iteratively obtains the solution to the governing equations for radiation transport on the computational grid.

In certain embodiments of the present invention, Ray tracing of the primary flux is performed using a finer energy group structure than that used for a subsequent deterministic radiation transport calculation, and the optical path length calculated on a finer spatial resolution grid than is used for the deterministic transport calculation. In one embodiment of the present invention, ray tracing is performed to the Gaussian integration points of each element in the computational grid existing within the primary field path. This enables the first scattered source at the unknown flux locations to be rigorously computed by using finite element integration rules on the element.

In this context, unknown flux locations refer to the points in each element for which the flux is solved according to the linear or higher order polynomial representation of the solution specified within the element, solved with a finite element method. For linear representations, the unknown flux locations are generally the corner nodes of each element. For higher order polynomial representations, additional internal points are used based on the specific polynomial order and element type.

A single-collision deterministic calculation can be used to transport collided components of the source through field shaping devices.

A spatially variable material distribution can be assigned within each element of the computational grid, such that a unique material composition is associated with each unknown flux location. In this context, unknown flux locations refer to the points in each element for which the flux is solved according to the linear or higher order polynomial representation of the solution within the element, solved with a finite element method.

Prior to performing the transport calculation, local adaptation based on the primary flux and material properties may be performed by increasing the order of the flux representation calculated in each element, on an element-wise basis.

Elements existing outside the primary radiation field, and beyond a threshold distance from the primary radiation field, may be deleted or suppressed for the transport calculation.

For coupled photon-electron applications, such as dose calculations for external beam radiotherapy, the electron transport may be performed on a separate, finer resolution grid than that used to calculate the photon transport. In such cases, ray tracing of the primary radiation field may be performed directly to the unknown flux locations of the elements in the electron transport grid.

The primary photon source may then be mapped to the unknown flux locations of the coarser photon grid to calculate the photon transport. The electron source calculated by secondary photons can be mapped to unknown flux locations of the electron transport grid.

The electron transport calculation is performed using the electron source summed from both the primary and scattered photons.

In cases where the calculated dose is only needed in high dose regions, the electron transport grid may be reduced to only include those elements where the electron source is greater than a defined threshold, and adjacent elements located within a threshold optical distance of elements exceeding this threshold.

The transport calculation, when using discrete-ordinates angular discretization (S_{N}), may employ an adaptive S_{N} order, for which the angular resolution of the transport calculation can be dependent on incident beam parameters, and may be independently specified for each particle type and energy.

For image reconstruction, a last-collided-flux method may be employed to transport the scattering source, computed from the deterministic transport calculation, via ray tracing from the computational grid to determine the angular and energy dependent flux (last-collided-flux) incident on a detector which may be located externally to the computational grid.

For external beam radiotherapy treatment planning, a deterministic adjoint capability may be used to calculate the importance flux (contribution) for any point in the computational grid to the adjoint source, repeated for as many adjoint sources as where the dose is of interest, prior to treatment planning. The dose distribution for a selected treatment plan can be reconstructed by using a ray tracing based last-collided-flux method to transport the adjoint scattering source from the computational grid to locations where the treatment parameters are known. In this manner, the patient dose can rapidly be calculated during treatment planning for any gantry position, orientation, and field shape.

The local dose can be extracted at a finer resolution than the computational grid elements by multiplying the local flux corresponding to the centroid of an acquired image pixel or an alternative fine grid material representation, by the dose response function for the material in the corresponding image pixel. The local flux, as used above, can be extracted from the higher order solution representation solved for in the deterministic transport calculation.

Various embodiments of the present invention provide methods and systems for performing deterministic calculations of radiation transport within anatomical regions for radiotherapy and imaging dose calculations and non-anatomical regions for industrial sterilization, the prediction of scatter within anatomic regions for image reconstruction, and the prediction of scatter in phantoms, mechanical systems, or other non-anatomical bodies for image reconstruction in other applications. Although descriptions contained herein are provided for patient imaging and radiotherapy, the methods and systems are valid for any of the above.

Embodiments of the present invention provide for accurately transporting a localized radiation source into and/or through a computational grid of a patient to calculate the primary (un-collided) radiation flux, and from this determine the first-collided scattering source, used as input for a deterministic transport calculation.

Embodiments of the present invention provide for accurately and efficiently computing the angular and energy dependent flux seen by a detector, or any arbitrary point, surface or volume, which may be internal or external to the patient computational grid, resulting, either partly or entirely, from the deterministically calculated radiation transport solution.

Embodiments of the present invention provide methods for performing radiation dose calculations for many different forms of radiotherapy including, but not limited to, external photon beam treatments such as 3-D conformal radiotherapy, intensity modulated radiotherapy (IMRT), stereotactic radiosurgery, Tomotherapy® (Tomotherapy is a trademark of Tomotherapy, Inc.), proton beam radiotherapy, electron beam radiotherapy, heavy ion beam radiotherapy, neutron capture therapy, brachytherapy, and targeted radionuclide therapy. Embodiments of the present invention provide for performing dose dose calculations for both diverging and converging radiotherapy beams. Similarly, embodiments of the present invention also provide for dose calculations resulting from imaging modalities.

Embodiments of the present invention provide methods for performing radiation transport simulations to predict radiation scatter for image reconstruction of imaging modalities such as CT, PET, SPECT, and other radiography methods, and a range of optical imaging techniques, including small animal imaging.

In one embodiment of the present invention, the methods may be used to predict both delivered dose and radiation incident upon detectors, for image reconstruction or verifying delivered doses, possibly through a single radiation transport calculation.

Process Overview

The system and method outlined herein describes a process whereby computational simulations are performed for radiation transport including the following: (1) transport from a localized source through air or void space, and potentially through field shaping devices, into an anatomical region, (2) transport within an anatomical region resulting from either an externally transported radiation source or an internal radiation source, and (3) transport of a computed radiation field from an anatomical region to points external such as detectors.

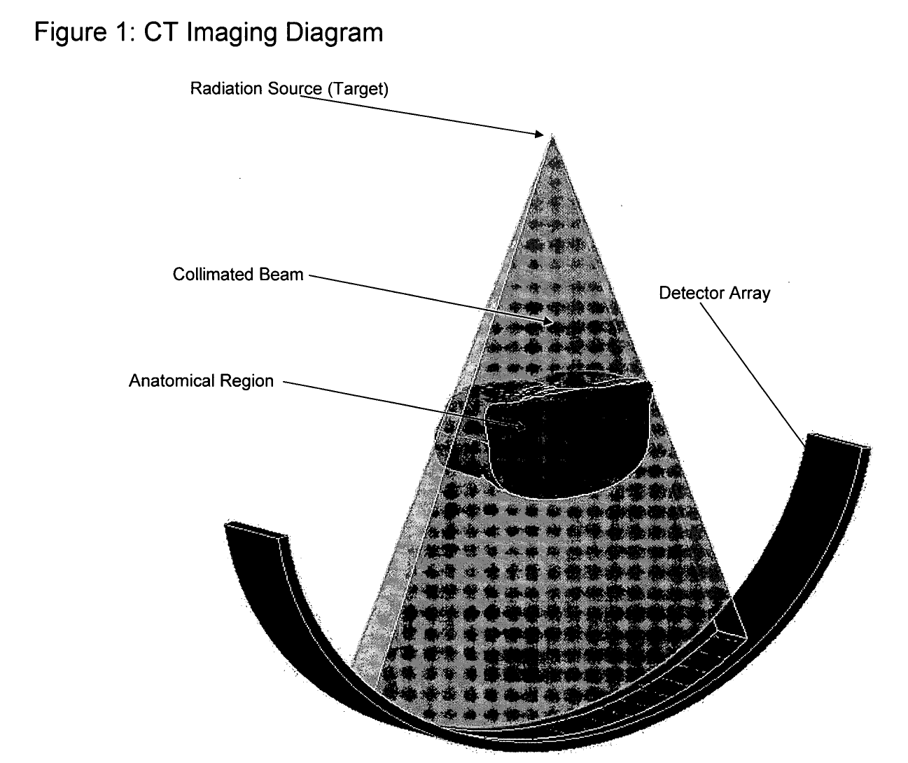

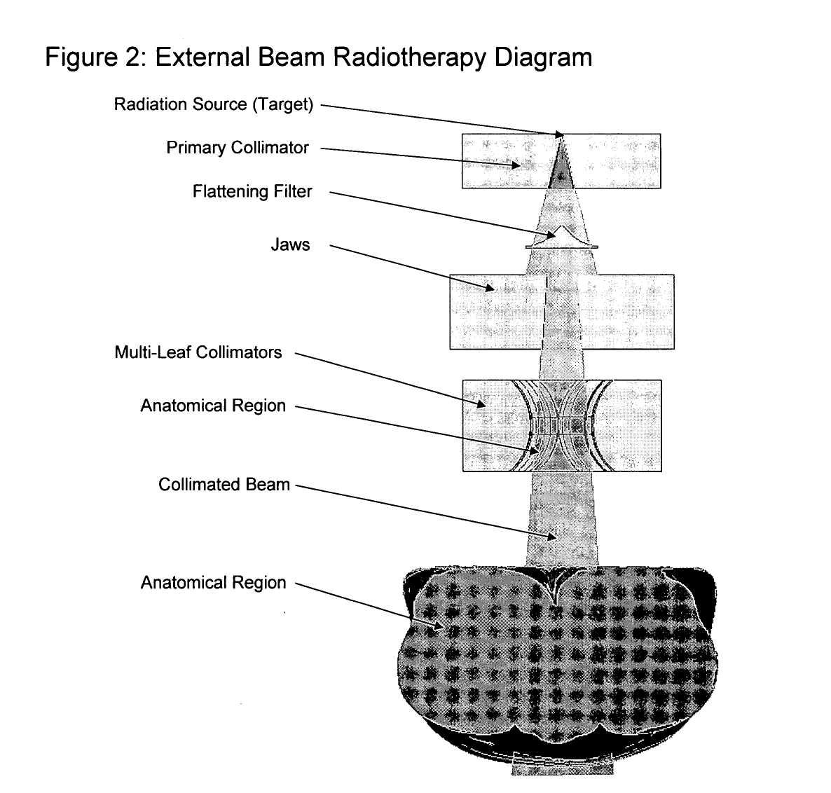

For image reconstruction and dose calculations, imaging and radiotherapy modalities may incorporate one or more of the above steps. For CT imaging, a localized source may be collimated to a fan or cone beam profile, which is projected on to an anatomical region (FIG. 1). An array of detectors is situated opposite the anatomical region. For imaging modes such as PET and SPECT, and targeted radionuclide radiation therapies, the radiation source may be internal to the patient, and external detectors are used to measure the activity, and thus the source distribution, inside an anatomical region. For external beam radiotherapy modalities, a localized source is collimated and transported into an anatomical region (FIG. 2). For brachytherapy, sources are placed internal to the anatomical region.

Solution Method

In one embodiment, the method uses a deterministic solution method which iteratively solves the differential form of the linear Boltzmann transport equation (LBTE) by discretizing in space (finite-element), angle (discrete-ordinates), and energy (multi-group cross sections). For charged particles, the Generalized Boltzmann-Fokker-Planck transport equation (GBFPTE) is solved:

$$\hat{Ω} \cdot \vec{∇} Ψ ( \vec{r} , E , \hat{Ω} ) + {σ}_{t} ( \vec{r} , E ) Ψ ( \vec{r} , E , \hat{Ω} ) - \frac{\partial }{\partial E} S ( \vec{r} , E ) Ψ ( \vec{r} , E , \hat{Ω} ) - [ HOFPT ] = {\int }_{0}^{∞} {\int }_{4 π} {σ}_{s} ( \vec{r} , {E}^{′} \to E , \hat{Ω} \cdot {\hat{Ω}}^{′} ) Ψ ( \vec{r} , {E}^{′} , {\hat{Ω}}^{′} ) ⅆ {E}^{′} ⅆ {\hat{Ω}}^{′} + Q ( \vec{r} , E , \hat{Ω} ) , \qquad ( 1 )$$

along with appropriate boundary conditions. Here, \vec{r} is the particle position in space, \hat{Ω} is the particle position, E is the particle energy, σₜ is the macroscopic total cross section, σₛ is the macroscopic differential scattering cross section for soft collisions, S is the restricted stopping power, ψ is the particle angular flux and Q is the fixed source. The term in brackets, [HOFPT] represents any additional higher order Fokker-Planck terms in addition to the first order term, ∂S_{ψ}/∂E, which is the continuous slowing down operator.

The GBFPTE includes all terms of the LBTE, including Boltzmann scattering for the nuclear interactions, with the addition of the continuous slowing down operator and continuous scattering operator, which account for Coulomb interactions.

In one embodiment, the solver will allow adaptation in angular quadrature order (S_{N}) by group, by particle type, or a combination thereof, and similarly, adaptation in the order of spherical harmonics moments representation of the scattering source (P_{N}) by group, by particle type, by space, or a combination thereof.

Computational Grids

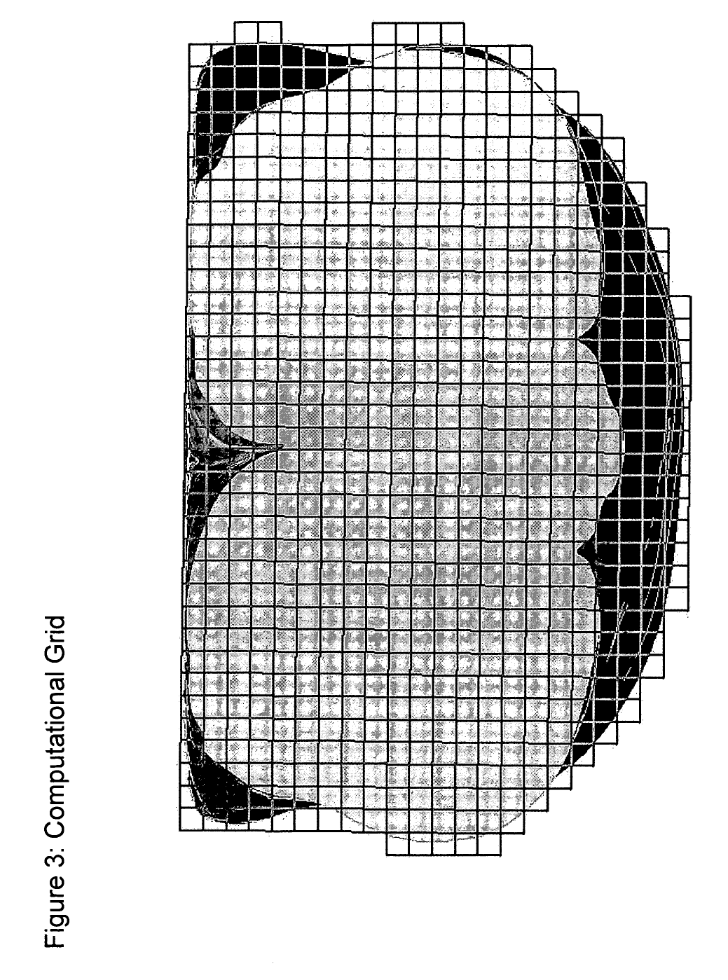

In one embodiment, the computational domain in the patient volume, hereafter referred to as the patient grid, is constructed of uniformly sized Cartesian elements, and includes elements which are either fully contained within, or partially overlap, the imaged region boundaries (FIG. 3).

In the current nomenclature, the term ‘patient grid’ may also apply to nonanatomical structures where the dose is to be calculated, or of which an image is reconstructured. Such will be true for cases such as industrial imaging or sterilization.

Since elements are connected along paths where radiation is transported in the deterministic calculation, a convex external boundary to the patient grid may be preserved.

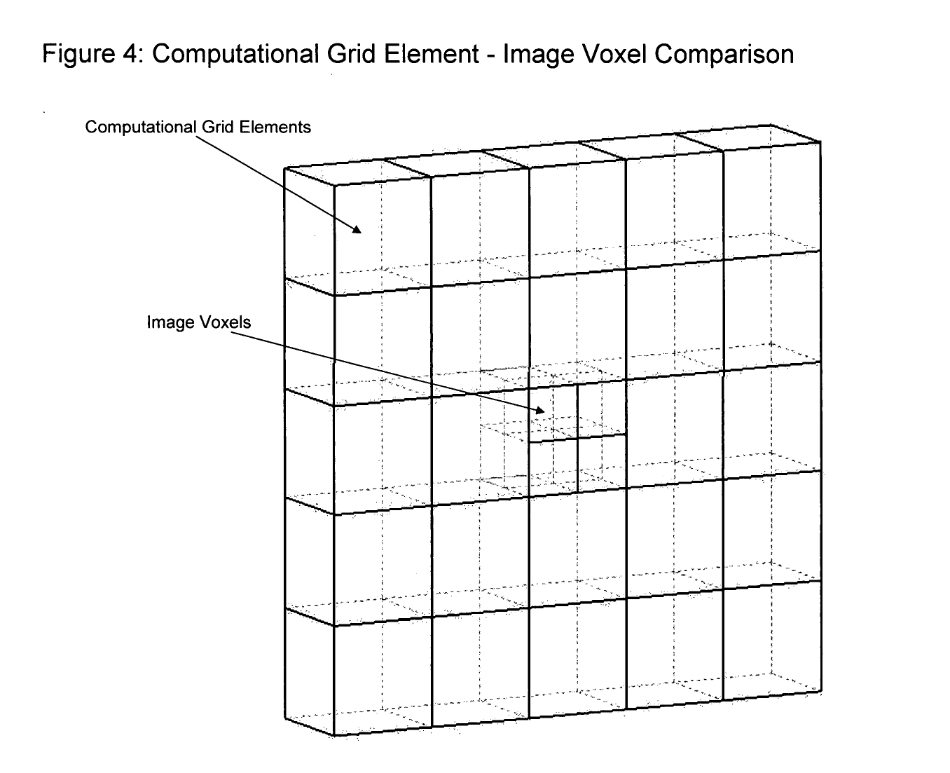

In one embodiment, each grid element will comprise an integral number of image voxels (FIG. 4).

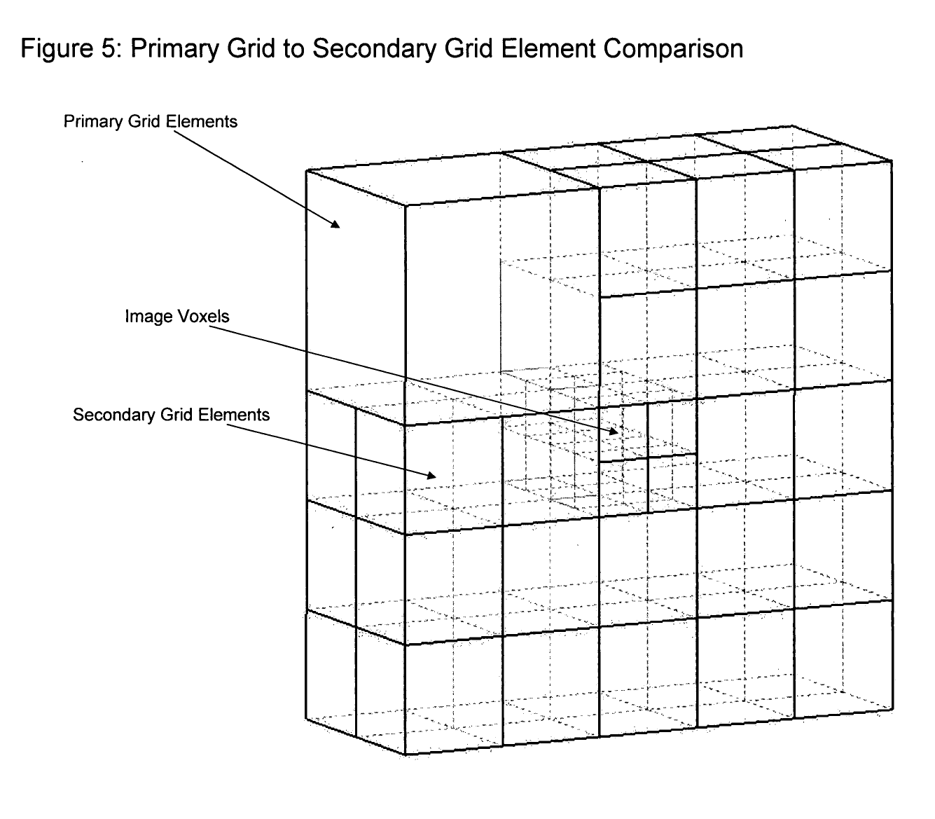

When secondary particle types, those produced by the primary particle type, are to be transported, separate patient grids may be used for each particle type. An example is photon beam radiotherapy, where secondary electrons, produced by photons, are also transported. In such cases, two separate patient grids: a primary patient grid (photon transport), and a secondary patient grid (electron transport) with smaller elements. In one embodiment, each element in the primary patient grid will contain an integral number of elements from the secondary patient grid (FIG. 5).

The term ‘patient grid’ is used to describe characteristics common to both the primary and secondary patient grids.

Alternative embodiments may include unstructured mesh topologies for which the patient grids may consist of any combination of element shapes and types, such as arbitrarily sized and shaped tetrahedral, hexahedral, prismatic, pyramidal, and polyhedral elements, or combinations thereof. These element types may also be linear or any higher order. Unstructured meshes may also incorporate embedded (i.e. hanging node) localized refinement or arbitrary mesh interfaces, which relax nodal connectivity constraints.

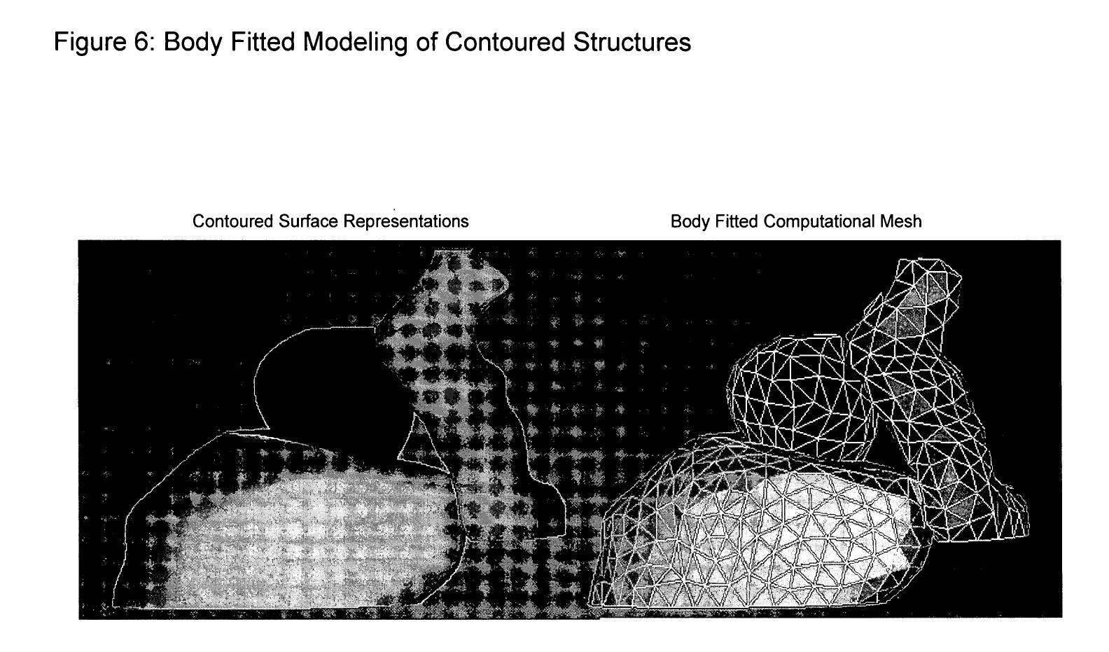

An embodiment for unstructured mesh topologies is to enforce a body-fitted mesh representation of contoured regions (FIG. 6). In such a manner, an integral number of elements is contained in each contoured region.

In one embodiment, element sizes in the patient grid will be driven by the resolution desired in the deterministic transport solution, and not in calculation of the primary or last-collided-fluxes. Thus relatively coarse element sizes may be applied.

Mapping of Material Properties to the Patient Grid

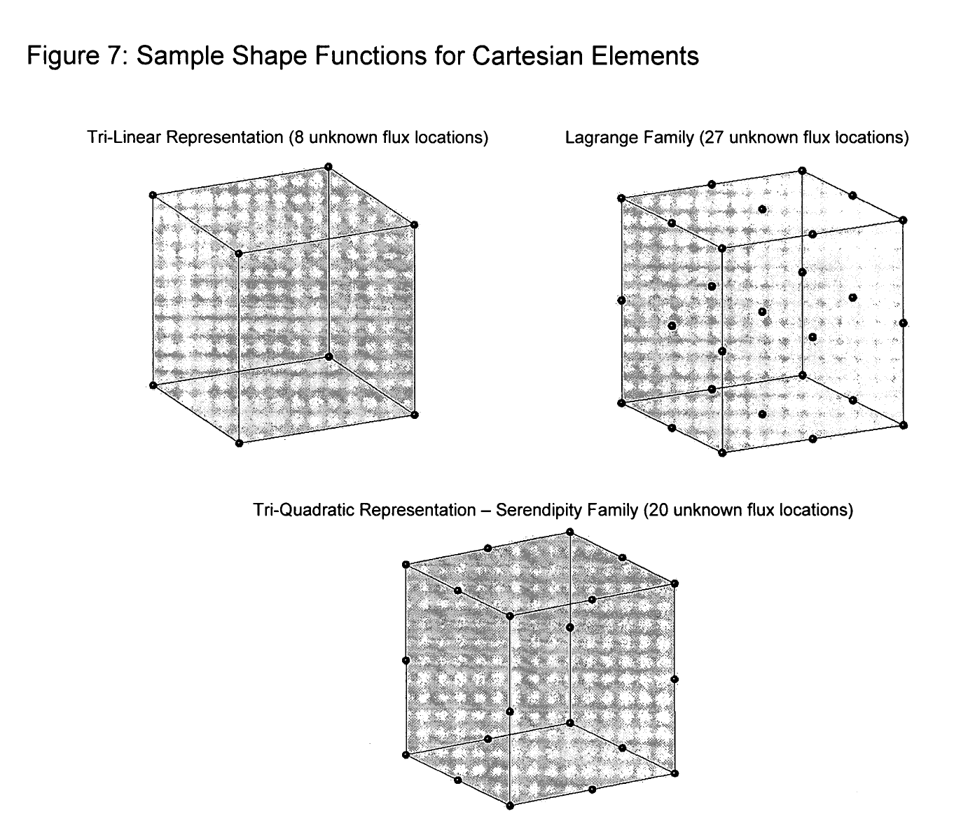

In one embodiment, the material properties, or cross sections, within each patient grid element will be grouped into piece-wise constant regions, such that unique material properties will be assigned to each unknown flux location in the patient grid (FIG. 7). Other embodiments may also exist where unique material properties are assigned to each unknown flux location.

In a piece-wise constant representation, material properties will be determined by averaging the raw image pixels, on a volume weighted basis, within the volume associated with each unknown flux location. If the volume of each image pixel is entirely contained within a single patient grid element, as is specified in one embodiment, a straightforward mapping process may be used to assign material properties to each unknown flux location.

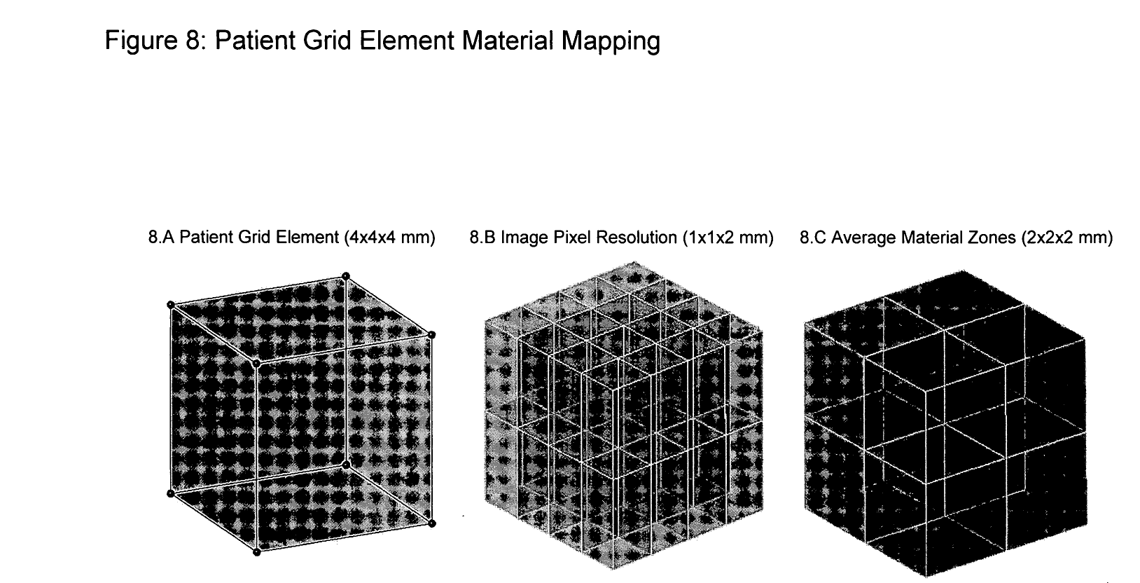

As an example, for a raw image pixel size of 1×1×2 mm, a patient grid element size of 4×4×4 mm will contain 32 image pixels (FIG. 8). If a tri-linear discontinuous solution representation is applied in a Cartesian element, unique material properties may be calculated at 8 discrete regions, each containing 2×2×1 pixels. In this manner, separate material properties may be specified at each of the 8 unknown flux locations. If the above element size is for the secondary patient grid, and the primary patient grid uses Cartesian element sizes of 8×8×8 mm with a tri-linear discontinuous solution representation, the material properties at each of the 8 unknown flux locations in the primary patient grid elements may be calculated by averaging the material properties in each of the 8 corresponding secondary patient grid elements contained in the primary grid element.

If multiple calculations are to be performed using a single image, such as the case with radiotherapy treatment planning, material regions may be calculated and mapped to associated unknown flux points for linear and higher order representations (shape functions), and stored in memory or disk, prior to performing any transport calculations. This will allow higher order solution representations to be rapidly applied, where needed, on an element-by-element basis, where higher spatial precision is desired.

Transport of Primary Flux

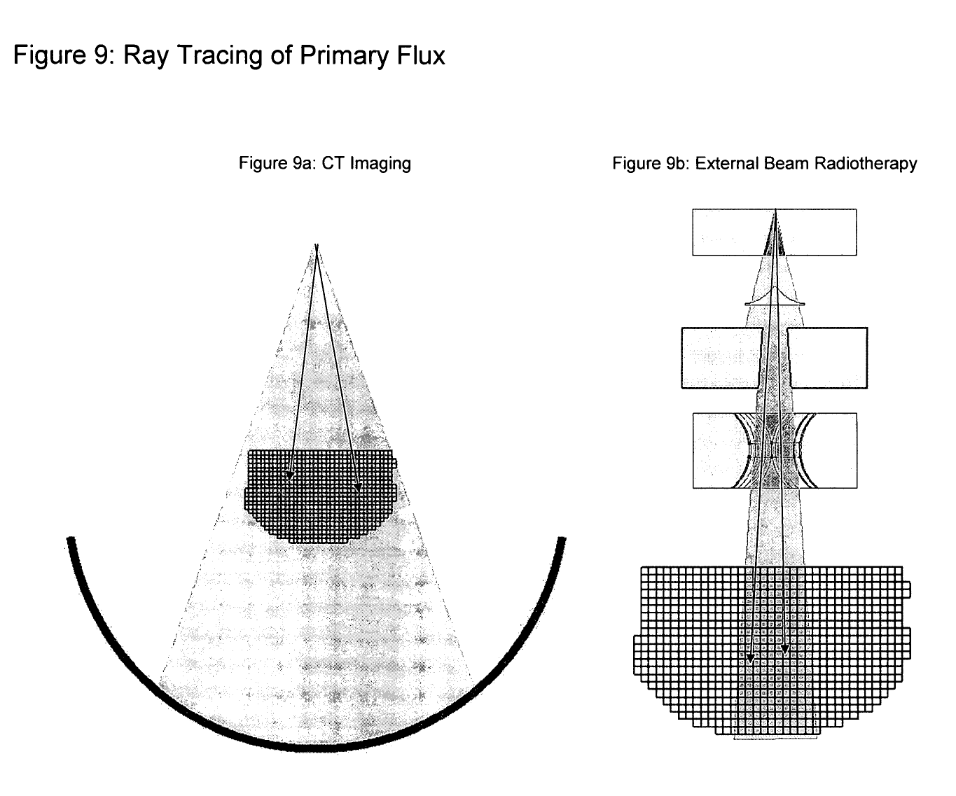

In many imaging and radiotherapy modalities, the primary radiation source is highly localized, and may be internal (brachytherapy) or external (beam radiotherapy) to the patient grid. In many such cases, the primary source is represented using one or more point sources, each having an angular dependent intensity and energy spectrum, which are transported via ray tracing through the air, and possibly field shaping components, and into the patient grid (FIG. 9). The scattering source in the patient grid is calculated from the primary flux, and is hereafter referred to as the ‘first scattered source’, and the total transport solution can then be obtained by summing the primary and scattered flux components.

For a point source located at \vec{r}ₚ, the primary flux can be calculated as shown below, simplified for a single energy group vacuum boundaries and an isotropic point source:

$$\hat{Ω} \cdot \vec{∇} Ψ ( \vec{r} , \hat{Ω} ) + {σ}_{t} ( \vec{r} ) Ψ ( \vec{r} , \hat{Ω} ) = {Q}^{scat} ( \vec{r} , \hat{Ω} ) + \frac{{q}^{p}}{4 π} δ ( \vec{r} - {\vec{r}}_{p )} . \qquad ( 2 )$$

The total flux is equivalent to the summation of the primary and collided flux components:
Ψ(\vec{r},\hat{Ω})=Ψ^{(u)}(\vec{r},\hat{Ω})+Ψ^{(c)}(\vec{r},\hat{Ω}), (3)
Ψ^{(u)} is the uncollided angular flux and Ψ^{(c)} is the collided flux. Equation (2) can be described by the following two equations:

$$\begin{matrix}\hat{Ω} \cdot \vec{∇} {Ψ}^{( u )} ( \vec{r} , \hat{Ω} ) + {σ}_{t} ( \vec{r} ) {Ψ}^{( u )} ( \vec{r} , \hat{Ω} ) = \frac{{q}^{p}}{4 π} δ ( \vec{r} - {\vec{r}}_{p )} , & ( 4 ) \\ \hat{Ω} \cdot \vec{∇} {Ψ}^{( c )} ( \vec{r} , \hat{Ω} ) + {σ}_{t} ( \vec{r} ) {Ψ}^{( c )} ( \vec{r} , \hat{Ω} ) = {Q}^{scat , ( c )} ( \vec{r} , \hat{Ω} ) + {Q}^{scat , ( u )} ( \vec{r} ) , & ( 5 )\end{matrix}$$

where Q^{scat,(u)}(\vec{r}) is the first collision source and is evaluated using Ψ^{(u)}(\vec{r},\hat{Ω}) in Eq. (?6).
Eq. (4) can be solved analytically for the uncollided angular flux:

$${Ψ}^{( u )} ( \vec{r} , \hat{Ω} ) = δ ( \hat{Ω} - \frac{\vec{r} - {\vec{r}}_{p}}{\vert \vec{r} - {\vec{r}}_{p} \vert} ) \frac{{q}^{p}}{4 π} \frac{{ⅇ}^{- τ ( \vec{r} , {\vec{r}}_{p} )}}{{\vert \vec{r} - {\vec{r}}_{p} \vert}^{2}} , \qquad ( 6 )$$

where the spherical harmonic moments of the uncollided angular flux become:

$${ϕ}_{l}^{m , ( u )} ( \vec{r} ) = {Y}_{l}^{m} ( \frac{\vec{r} - {\vec{r}}_{p}}{\vert \vec{r} - {\vec{r}}_{p} \vert} ) \frac{{q}^{p}}{4 π} \frac{{ⅇ}^{- τ ( \vec{r} , {\vec{r}}_{p} )}}{{\vert \vec{r} - {\vec{r}}_{p} \vert}^{2}} \qquad ( 7 )$$

Here τ(\vec{r}, \vec{r}ₚ) is the optical distance between \vec{r} and \vec{r}ₚ.

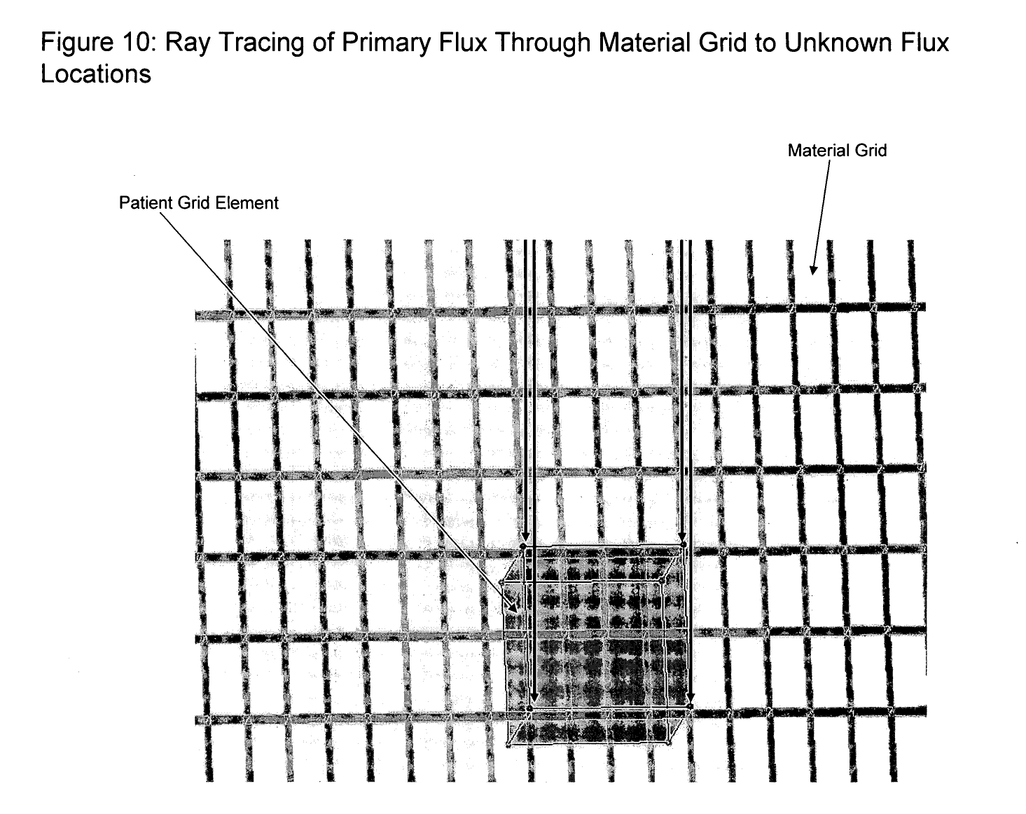

In one embodiment, τ(\vec{r},\vec{r}ₚ) is calculated by ray tracing from the source, through a fine resolution material grid, to the Gaussian integration points, for a specified polynomial order, of each selected element in the patient grid. This enables the first scattered source at the unknown flux locations to be rigorously computed by using finite element integration rules on the element. In another embodiment, ray tracing may be performed to the unknown flux locations of each element (FIG. 10).

In certain embodiments of the present invention, Ray tracing of the primary flux is performed using a finer energy group structure than that used for a subsequent deterministic radiation transport calculation, and the optical path length calculated on a finer spatial resolution grid than is used for the deterministic transport calculation.

The term “material grid” refers to the discretized representation of the anatomical regions in which elements (or voxels) may be equal in size to: raw image data pixels, elements in the secondary patient grid (electrons), or an alternative fine grid.

If elements of the material grid are larger than pixels in the raw image data, a homogenized material representation may exist within each element of the of the ray tracing grid, where data from multiple raw image pixels are volume averaged within each material grid element (FIG. 8).

For rays where the incident flux is less than a defined threshold, ray tracing along that angle may be omitted.

For image reconstruction, ray tracing may be performed from the source to each detector in the field. During this process, the primary flux in each material grid element a ray passes through may be stored. Therefore, ray tracing may only need to be repeated for those elements whose primary flux was not calculated in the original, source-to-detector calculation.

In external photon beam radiotherapies, explicit transport of both photons and secondary electrons may be carried out. In these modalities, a majority of the patient dose is generally due to electrons produced by primary photons. In one embodiment, ray tracing of the primary photon source will be performed to the unknown flux locations of the secondary patient grid, which is used to transport electrons.

To obtain the first scattered photon source, which is transported on the primary patient grid, ray tracing may also be performed to the unknown flux locations of the primary patient grid. Alternatively, the first scattered source from the secondary patient grid may be mapped to the unknown flux locations of the primary patient grid. In one embodiment, a 1:1 relationship will exist between secondary grid elements and the unknown flux locations of the primary grid elements, which allows a direct mapping of the photon scattering source to be performed to the unknown flux locations of the primary grid elements.

Mapping of the photon scattering source from the electron transport grid (secondary grid) to unknown flux locations of the photon transport grid (primary grid) may be accelerated by precalculating the relationship of primary to secondary grid elements.

A variety of higher order representations (shape functions) can be employed, which can vary with the element type. Some examples are shown in FIG. 7.

If multiple calculations are to be performed on a single image representation, such as is commonly done for radiotherapy, the source distribution in each patient grid element may be calculated using two or more shape functions, and stored in memory or disk, prior to computing any transport solutions.

Adaptation Methods

In one embodiment, adaptation is performed to locally improve the spatial resolution of the solution where needed, prior to performing the transport calculation. In this embodiment, the level of adaptation for each element is determined by two field values, which may be used separately, or in combination with each other: (1) material properties within each element, and (2) solution of the primary flux, or first scattered source, within each element. A variety of manual criteria may also be applied, such as proximity to critical structures, etc.

Process Incorporating Adaptation in the Solution Order within each Element

In one embodiment, adaptation is performed by selectively varying, on an element by element basis, the order of the polynomial solution representation (shape function) within each element. In this manner, a lowest order representation will be selected which is used in elements that do not satisfy the adaptation criteria. In one embodiment, this may be a linear discontinuous representation. Those elements which satisfy such criteria will incorporate a higher order shape function, such as quadratic or cubic discontinuous representation. In one embodiment, unique material properties will be assigned to each unknown flux location, regardless of the solution order within that element.

In one embodiment, the primary criteria for which adaptation is based include the following:

Δ_{PF} Threshhold variation in the primary flux within an element

Max_{PF} Threshhold value of the primary flux within an element

Δ_{σT} Threshhold variation in the material cross sections within an element

Max_{σ} Threshhold value of the material cross sections within an element

Evaluation of the material cross sections within an element may be based on raw image data, values at the unknown flux locations, or some alternative method. Various parameters of the material cross sections may be used for the adaptation, in which the general goal is to identify spatial variations in material properties.

The optimal approach for applying the above parameters in determining the local adaptation level is dependent on the spatial resolution achievable with the lowest order representation and selected computational element sizes. In one embodiment, this combination will be sufficient to resolve the solution in a majority of the solution field. If this combination is sufficient to resolve the solution within the primary flux field and dense materials, in areas where large gradients do not exist, adaptation may only need to be performed to resolve solution field gradients produced by material heterogeneities and spatial variations in the primary flux. The following outlines one embodiment of a process for performing adaptation:

In one embodiment, adaptation based on material gradients is only performed for those elements which intersect the path of the primary flux. In this embodiment, the Max_{PF} criteria is evaluated first by: (1) calculating the primary flux, PF(i,j), at each location, j, for which the primary flux has been calculated in each element, i, in the patient grid; (2) looping through each of the elements where the primary flux is calculated in order to (a) find the location where the maximum flux occurs, jₘₐₓ; and (b) determine whether PF(i,jₘₐₓ)≧Max_{PF}.

For elements in which PF(i,jₘₐₓ)≧Max_{PF}, the Δ_{σ} criteria is then evaluated: (1) calculating the total cross section, σ_{T}(i,j), at each unknown flux location, j, in each element, i, for which PF(i,jₘₐₓ)≧Max_{PF}; (2) looping through each of the elements where the cross sections are calculated in order to (a) find the location where the maximum material cross section occurs, jₘₐₓ; (b) find the location where the minimum material cross section occurs, jₘᵢₙ; (c) calculate the maximum difference in the total cross section within the element σ_{T}(i)=σ_{T}(i,jₘₐₓ)−σ_{T}(i,jₘᵢₙ). If σ_{T}(i)≧Δ_{σT}, then the solution order will be increased in that element.

A slight variant to the above may be to adapt based on material type. In many cases, the translation of image pixel values to material properties may assign a discrete material type (bone, lung, tissue, etc.) to a range of CT numbers, where the density of that material is based on the location of the CT number within that material range. As an example, a simple adaptation based on material type may increase the solution order for any transport grid element in the primary beam path where bone is present.

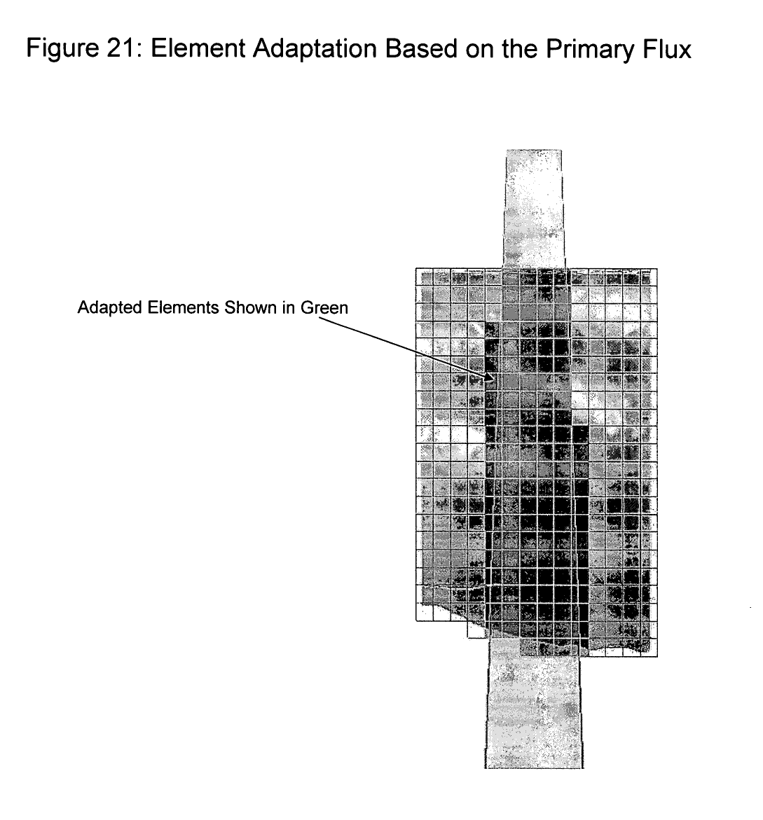

Another variant to the above may be to adapt based on the primary flux magnitude only, whereby those elements whose primary flux exceeds Max_{PF} are adapted, regardless of the material properties (FIG. 21). This is one embodiment for medical image reconstruction.

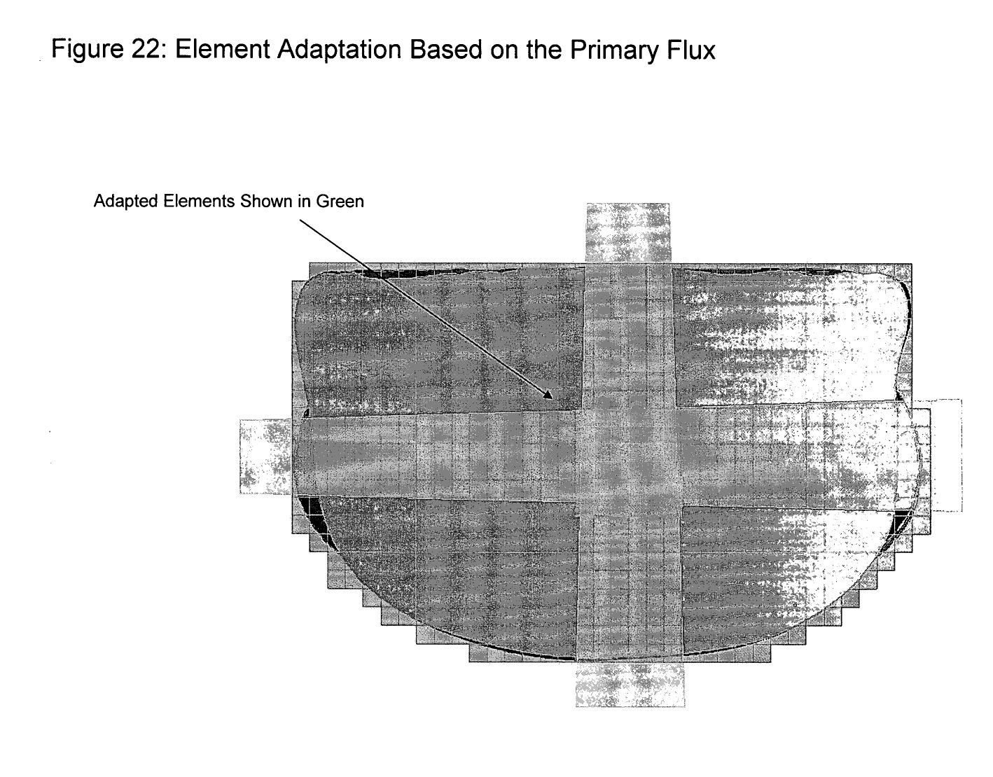

For radiotherapy applications, where multiple beams may converge on the treated region, the Max_{PF} threshold alone may be used to adapt in the high dose regions by defining Max_{PF} as a value higher than that produced by a single beam (FIG. 22).

Sharp gradients in the primary flux are characteristic of imaging and radiotherapy applications. In many cases, precisely resolving beam gradients is important. In one embodiment, the magnitude difference in the primary flux within an element will be used to adapt on the gradient. Here, the Δ_{PF} criteria is then evaluated: (1) calculating the primary flux, PF(i,j), at each unknown flux location, j, in each element, i; (2) looping through each of the unknown flux locations in order to (a) find the location where the maximum primary flux in the element occurs, jₘₐₓ; (b) find the location where the minimum material cross section occurs, jₘᵢₙ; (c) calculate the maximum difference in primary flux within the element PF(i)=PF(i,jₘₐₓ)−PF(i,jₘᵢₙ). If PF(i)≧Δ_{PF}, the solution order will be increased in that element. Alternatively, j may represent the Gaussian integration points in an element to which ray tracing is performed to.

A variety of other adaptation processes may be employed based on the above methods. One such approach is to adapt on Max_{PF} to increase the solution order for elements located within the primary beam path, which may be performed in concert with material and primary flux gradient adaptation.

Mesh Adaptation Methods

The above methods could also be used in concert with mesh adaptation, as opposed to adapting the solution order. A variety of mesh adaptation techniques may be performed to resolve the solution based on the primary flux and material heterogeneities. These include selective element refinement, coarsening, and/or nodal movement to isotropically or anisotropically improve the local mesh resolution. Other alternatives include applying constraints to the original mesh generation process, such as using explicit or implicit surface definitions to prescribe the location of element faces.

One embodiment is to conformally resolve the primary field by forcing element faces to exist on the primary beam field perimeter. One approach is to explicitly or implicitly include surfaces defining the primary field perimeter as constraints in the mesh generation process. Here, an explicit surface definition may used to define the perimeter of the primary radiation field from a representative collimated radiation source. In concert with this, elements inside the primary source field, or in near proximity to the primary source perimeter, may be isotropically or anisotropically refined.

Another embodiment is to resolve the beam by modifying a previously created grid, preferably Cartesian, through subdividing elements that intersect the primary field perimeter. In this manner, existing nodes are not modified. New nodes are created where element edges intersect the surface defining the primary field perimeter. Elements insersecting this surface are suppresed, and new elements are created to fill the resulting void. The benefits of this approach are that for each change in the source field: (1) the entire computational mesh does not need to be recreated, and (2) mapping of the image material data to the computational grid only needs to be recalculated for the newly created elements. Elements that do not intersect the primary field perimeter are not modified.

A third embodiment is to adapt the solution field anisotropically based on the magnitude and/or gradients in the primary flux or material properties, using criteria similar to those applied for adaptation in the solution order.

Alternatively, numerous more advanced adaptation methods can be implemented for resolving the primary radiation field and material heterogeneities. Adaptation methods may use a combination of element refinement and/or coarsening, with anisotropic nodal movement to obtain an optimal structure. These adaptation techniques will be familiar to those skilled in the art of adaptive mesh generation. Adaptation based on proximity and location relative to beam definition surfaces and adaptation based on gradient and intensity of the un-collided flux, outlined above, may be used separately or in combination to obtain an optimal computational mesh structure.

Patient Grid Reduction

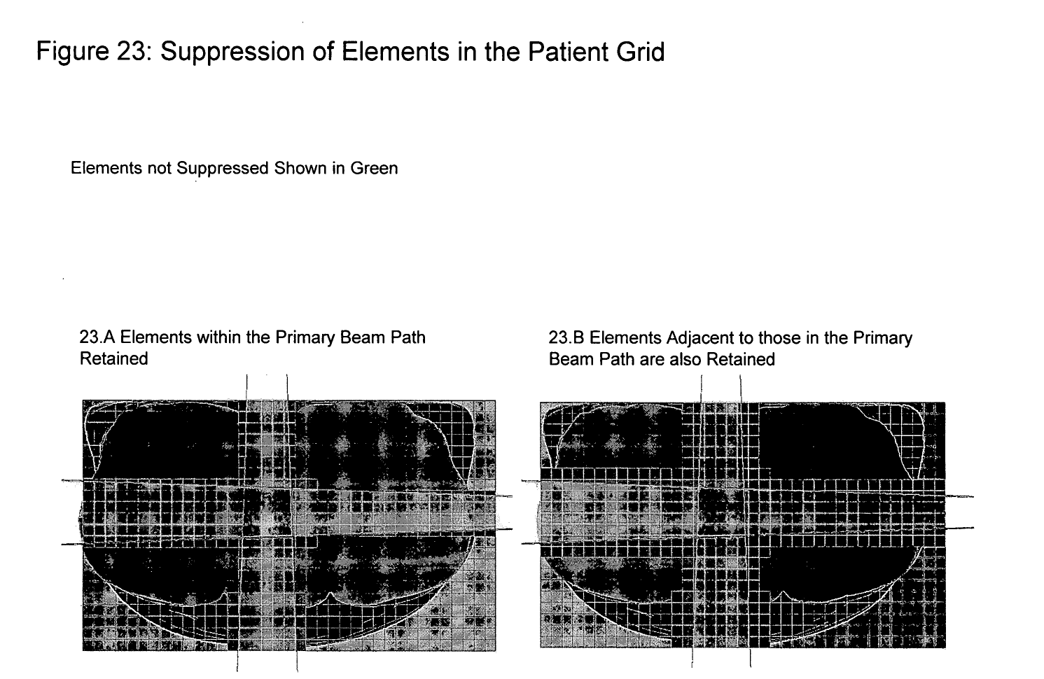

For many radiotherapy modalities, the dose field may be of interest only in specific regions, such as the planning treatment volume (PTV), critical structures or organs at risk (OAR), or other areas receiving relatively high doses. In one embodiment, elements will be selectively deleted from the patient grid after the primary flux calculation and prior to the transport calculation. In such a manner, the transport calculation can be performed on a grid with substantially fewer elements than the original patient grid encompassing the full anatomical volume. A similar approach may be performed for image reconstruction, where elements which exist outside the primary beam path, or for image reconstruction elements having a neglible effect on the contribution of scattered radiation incident on the detectors, may be deleted for the transport calculation. An example of this is shown in FIG. 23, where only elements inside the primary beam path, and adjacent elements, are used in the transport calculation. A preferred method for performing this is described below.
1. Parameters are specified which define the number of element layers beyond the beam perimeter and/or critical regions, for which elements will be retained:
   N_{PF}=Number of layers for which elements outside the primary flux region will be retained
   Ψₘᵢₙ=Minimum uncollided flux value defining the threshold of clinical interest, normalized by the max flux, Ψₘₐₓ, as determined by the maximum uncollided flux calculated from the primary field (0≦Ψₘᵢₙ≦1).
   N_{Dmin}=Number of layers for which elements outside the primary flux region will be retained
   In an alternative embodiment, the absolute distance or optical depth from the beam path may be used to determine which elements are retained, instead of explicitly specifying the number of layers.
2. Elements in which PF(i,jₘₐₓ)≧Max_{PF}, as was calculated in the adaptation process, are tagged as being located in the primary path. Alternatively, a primary flux threshold value different to that used for the adaptation may be employed.
3. Elements in which PF(i,jₘₐₓ)≧(Ψₘᵢₙ*Ψₘₐₓ) are tagged as being located within the dose regions of clinical interest. Since, in general, (Ψₘᵢₙ*Ψmax)≧Max_{PF}, this search needs only to be performed within those elements that have previously been tagged as being located in the primary beam path.
3. Elements adjacent to, defined by sharing a common surface (or edge or point in other embodiments) with elements in the primary beam path, are selected as being adjacent to the primary beam path.
4. Step 3 is performed N_{PF} times, each time calculating adjacencies to all previously selected elements from Step 3.
5. Elements adjacent to, defined by sharing a common surface (or edge or point in other embodiments), elements tagged as being within the dose regions of clinical interest are selected as being adjacent to the to the clinical dose regions of interest.
6. Step 5 is performed N_{Dmin} times, each time calculating adjacencies to all previously selected elements from Step 5.
7. Those elements not selected in any of the above steps are deleted from the model, or deactivated, prior to performing the transport calculation.

A similar process to the above can be applied for image reconstruction, where only those elements within, or in the near proximity to, the primary beam path may be included in the computational domain.

The above process can also be applied when dose distributions are of interest to regions other than the high dose regions or those in the primary beam path. This may include geometrically input region extents or previously contoured structures. For the latter, such contoured data can often be extracted directly from a format such as DICOM, where bounding contours are defined by specific pixel values. In such a manner, transport grid elements which overlap, partially or fully, the contoured structure can be selected, along with those elements within N layers from those overlapping the contoured structure.

Patient Grid Reduction by Particle Type

In applications such as external photon beam radiotherapy, it is necessary to explicity transport both photons and electrons. Due to the short range of electrons, an embodiment is for the secondary patient grid, where the electrons are transported, to be smaller in extent than the primary patient grid, where the photon transport is performed.

A preferred means to be perform this is to first identify those elements existing in the dose regions of clinincal interest, which are those elements where PF(i,jₘₐₓ)≧(Ψₘᵢₙ*Ψₘₐₓ). This set is then expanded to additionally include neighboring elements existing within N_{Dmin} layers of the elements existing in the dose regions within clinical interest. Note, N_{Dmin} may be specified as a different value than what is used for the primary patient grid. For regions containing substantial amounts of low density material, such as air, the optical depth to the clinical regions of interest may be used to determine which elements are retained, instead of explicitly specifying the number of layers.

Transport Cutoff for Electrons

Using the Generalized Boltzmann-Fokker-Planck transport equation (Equation 1), the dose at any position can be calculated from the following:

$$D ( \vec{r} ) = \frac{1}{ρ ( \vec{r} )} {\int }_{0}^{∞} {σ}_{ED} ( \vec{r} , E ) ϕ ( \vec{r} , E ) ⅆ E \qquad ( 8 )$$

Where σ_{ED} is the energy deposition cross section, ρ is the density and φ is the scalar flux as defined by:

$$ϕ ( \vec{r} , E ) = {\int }_{4 π} ψ ( \vec{r} , E , \hat{Ω} ) ⅆ \hat{Ω} . \qquad ( 9 )$$

Equation (1) can be solved using any spatial, angular, or energy differencing schemes commonly used or any differencing schemes developed in the future. For the charged particle energy cutoff, a spatial grid is applied whether unstructured or structured, connected or non-connected. The energy cutoff applies once the particle has reached a certain specified energy, E_{cut}. Below this energy it is assumed that the particles will only travel a very small distance before being absorbed and this distance is much smaller than the thickness of the spatial cell. For each spatial cell in the problem, all particles for which 0≦E<E_{cut}, the following approximation to Equation (1) will be solved:

$${σ}_{t} ( \vec{r} , E ) Ψ ( \vec{r} , E , \hat{Ω} ) - \frac{\partial }{\partial E} S ( \vec{r} , E ) Ψ ( \vec{r} , E , \hat{Ω} ) - [ HOFPT ] = {\int }_{0}^{∞} {\int }_{4 π} {σ}_{s} ( \vec{r} , {E}^{′} \to E , \hat{Ω} \cdot {\hat{Ω}}^{′} ) Ψ ( \vec{r} , {E}^{′} , {\hat{Ω}}^{′} ) ⅆ {E}^{′} ⅆ {\hat{Ω}}^{′} + Q ( \vec{r} , E , \hat{Ω} ) . \qquad ( 10 )$$

Effectively the particles are no longer transported in space and Equation (10) can be solved for each spatial cell in the spatial grid. Each cell is independent upon the others. This gives a tremendous reduction in CPU time since no spatial transport is necessary. Equation (10) can be further reduced by integrating over all angles to give:

$${σ}_{t} ( \vec{r} , E ) ϕ ( \vec{r} , E ) - \frac{\partial }{\partial E} S ( \vec{r} , E ) ϕ ( \vec{r} , E ) = {\int }_{4 π} ( {\int }_{0}^{∞} {\int }_{4 π} {σ}_{s} ( \vec{r} , {E}^{′} \to E , \hat{Ω} \cdot {\hat{Ω}}^{′} ) Ψ ( \vec{r} , {E}^{′} , {\hat{Ω}}^{′} ) ⅆ {E}^{′} ⅆ {\hat{Ω}}^{′} ) ⅆ \hat{Ω} + {\int }_{4 π} Q ( \vec{r} , E , \hat{Ω} ) ⅆ \hat{Ω} . \qquad ( 11 )$$

Equation (11) is independent of angle and is easily solved for each spatial cell. In one embodiment, the spatial transport of electrons below a defined energy cutoff will be ignored, either explicitly through solving the above equations, or by applying precalculated response functions for energy deposition based on the above equations.

Extracting Dose

In one embodiment, the dose field is extracted at a resolution finer than that of the elements used in the patient grid. As an example, if the dose field is desired at the resolution of the raw image data, the flux at the centroid of each image pixel may be calculated by applying the appropriate higher order finite element solution representation for the location in the patient grid element for which the centroid of the image pixel is located. This flux is then used to determine the dose in the material corresponding to the image data pixel.

Transport through Field Shaping Devices

The method of transporting an external source into the computational grid is dependent on the application. In one embodiment, transporting of the primary and scattered components will be performed through separate methods.

In a preferred embodiment, all radiation sources are first transported into the patient grid, and a single transport calculation is then performed on the patient grid which includes the primary and scattered components sources resulting from all beams.

Transporting the Primary Component

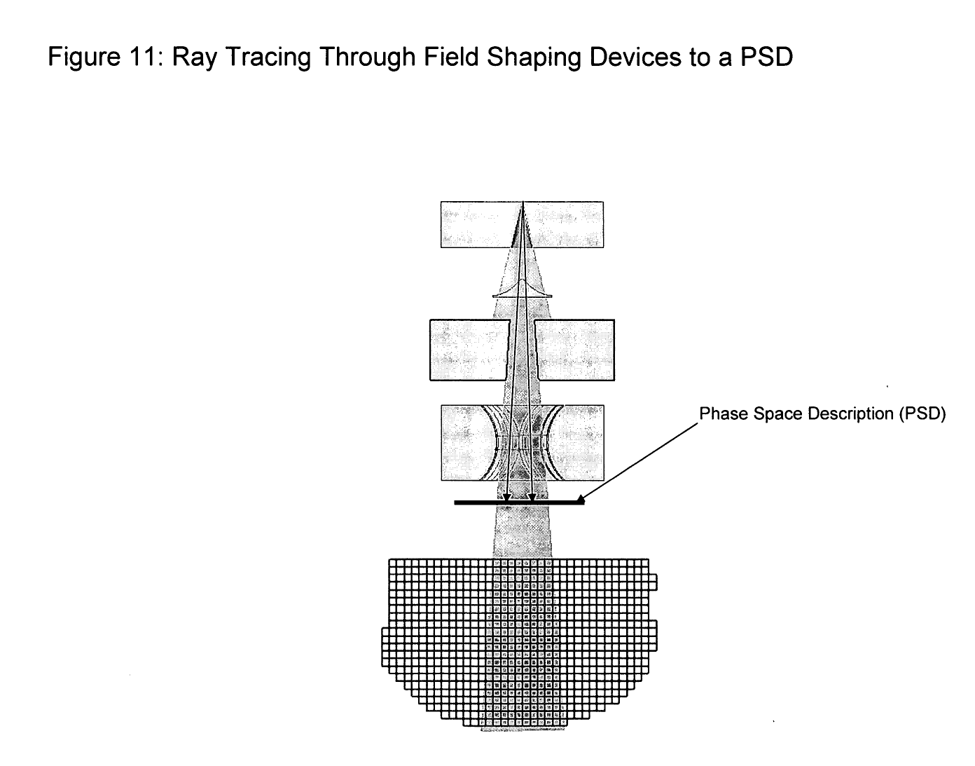

Preferred methods of transporting the primary flux are described below:
1. Where attenuation and scattering effects of field shaping devices can be ignored, or where their effects can be sufficiently modeled through a single anisotropic point source, ray tracing of the primary flux can be performed from the point source, through the air space or void, and into the patient grid. No explicit modeling of the field shaping components is required (FIG. 9a).
2. To account for attenuating effects through field shaping components, explicit modeling of relevant component surfaces may be carried out. A variety of surface geometry representations may be employed, though a computational grid of the field shaping components is not required. For static fields, where a radiation field is time invariant for a given source position and orientation, ray tracing may be performed from the point source, passing through the field shaping components to calculate optical depth, and into the patient grid. In this manner, attenuation in the primary flux due the field shaping components will be explicitly resolved (FIG. 9b).
3. In applications similar to (2), but where the radiation field for a given source position and orientation is time dependent (such as IMRT where moving collimators change the open field shape to create multiple fields for a single beam orientation), ray tracing may be performed from the point source and through the field shaping components to a plane where a phase space description (PSD) is applied (FIG. 11). This will be repeated for a sufficient number of collimator positions, using time based weighting for each position, to obtain the time integrated, angular and energy dependent, fluence map at the PSD. Through this approach, transport into the computational grid does not have to be repeated for each collimator position.
   Resolving the Scattered Component

If scattering effects are important, a variety of approaches may be employed in concert with any of the above methods for calculating the primary flux. This may include the use of deterministic solution methods to calculate the scattering contribution directly into the computational grid or up to a PSD.

One embodiment is to run a deterministic solver for a single collision. Here, the first collided source, obtained via ray tracing, is used as input to a transport calculation where only a single collision component is solved. Since each collision can be treated as a separate transport calculation, this can repeated multiple times as appropriate, where each subsequent calculation uses the scattered source obtained from the previous collision as input. The total flux, Ψ, is then obtained as follows:
Ψ=Ψ⁰+Ψ¹+Ψ²+ . . . Ψ^{∞} (12)
where, Ψ⁰ is the primary flux, which may be obtained via ray tracing, and Ψ¹ through Ψ^{∞} represent the collided flux components determined from each successive scattering event.

As an example, if Ψ¹ and Ψ² were obtained using single collision calculations, Ψ³ through Ψ^{∞} can be calculated to convergence using a multiple iteration transport calculation.

For modeling scattering effects within field shaping devices, one or two collisions may be sufficient to achieve sufficient accuracy.

In one embodiment, transport calculations through the field shaping devices will use a biased quadrature set, where angles are clustered around the primary beam direction.

With respect to computational grid generation, static and time dependent fields may be treated separately. For either case, a variety of methods may be employed, which may be similar to those described for computational grid generation in anatomical structures. In one embodiment, the computational mesh will be constructed with variably sized and oriented elements to optimize resolution in the direction of maximum gradients, while minimizing the total element count.

For dynamic fields, such as in IMRT, one embodiment is to construct a single computational grid which can be applied to all fields. This grid may be constructed to simplify the material mapping process. For example, the mesh may be aligned such that each element only occupies the region swept by a single collimator leaf. In addition, the matrix of material properties in each element as a function of leaf positions may be calculated prior to treatment planning, which can eliminate the need to perform interpolation real-time during a dose calculation.

Process for IMRT

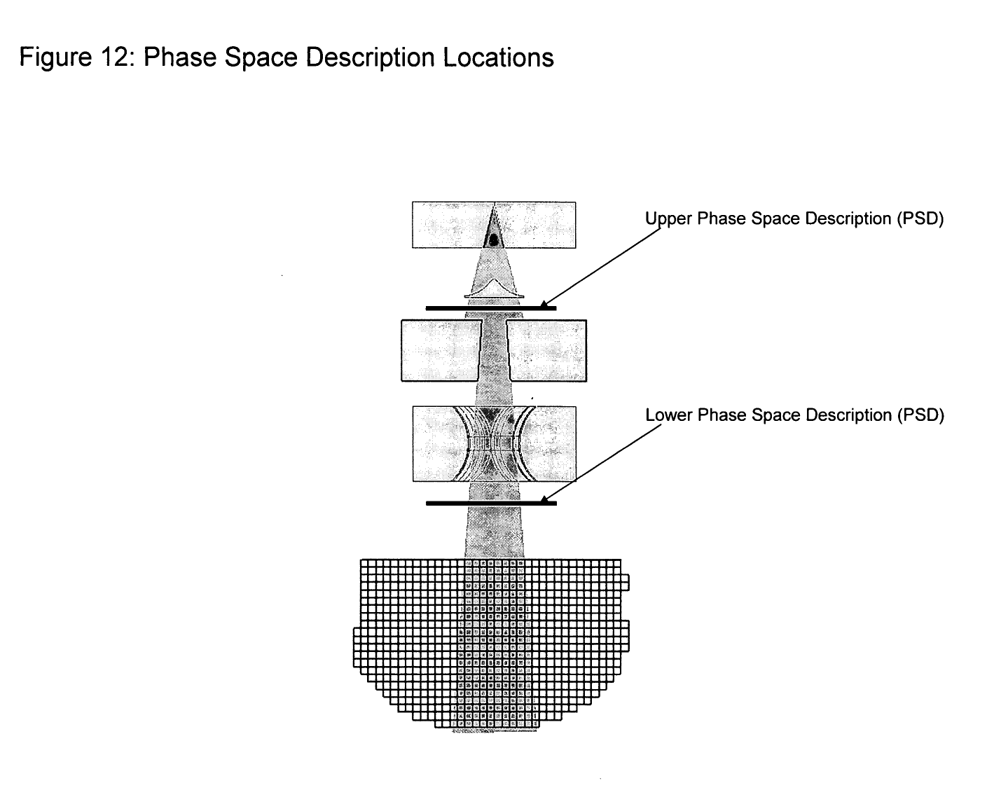

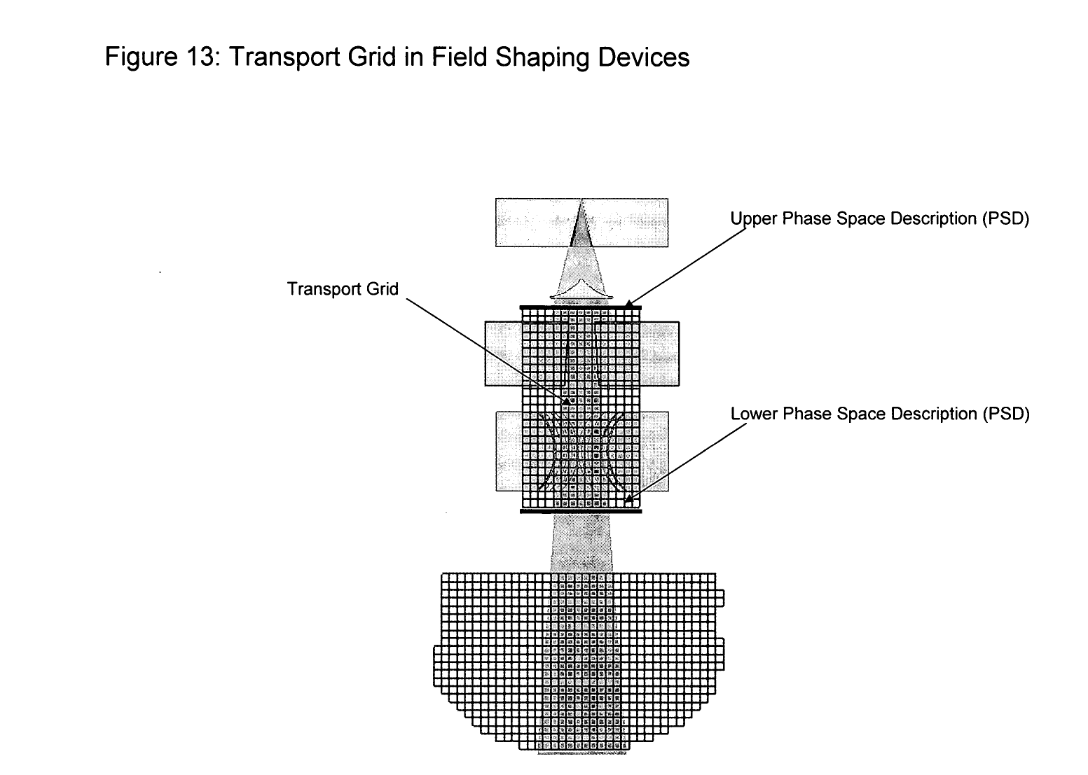

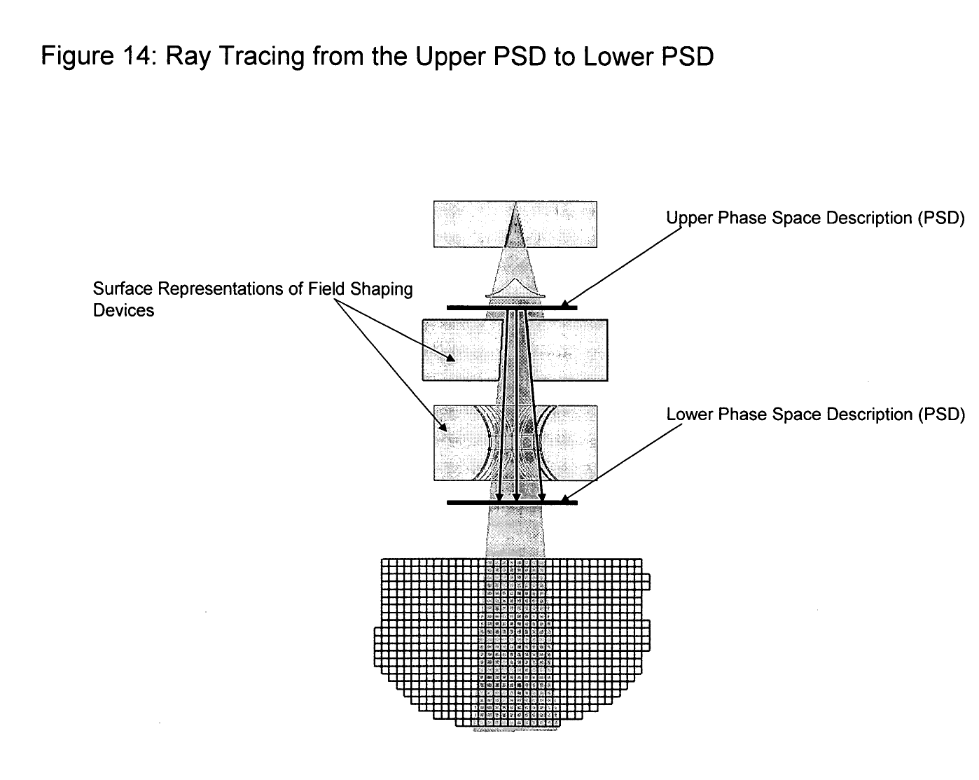

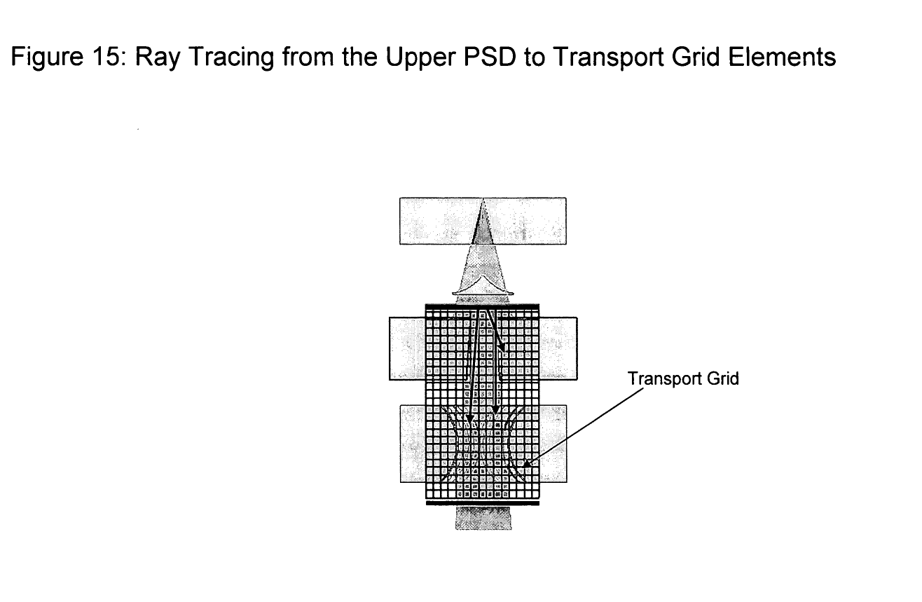

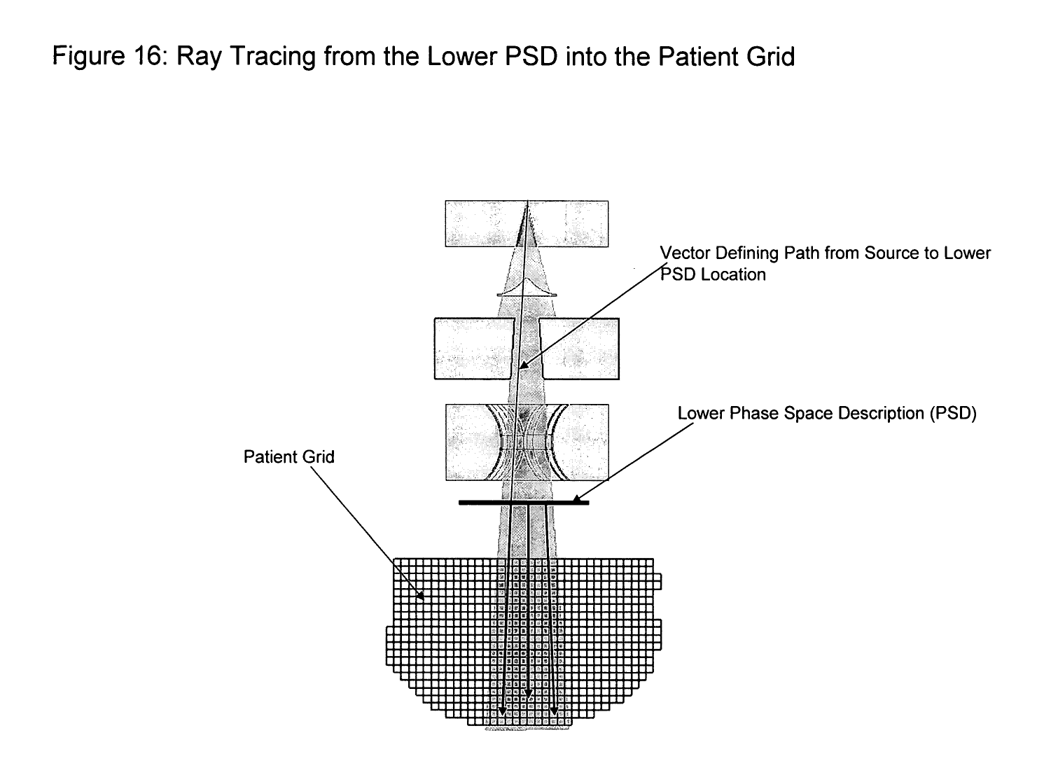

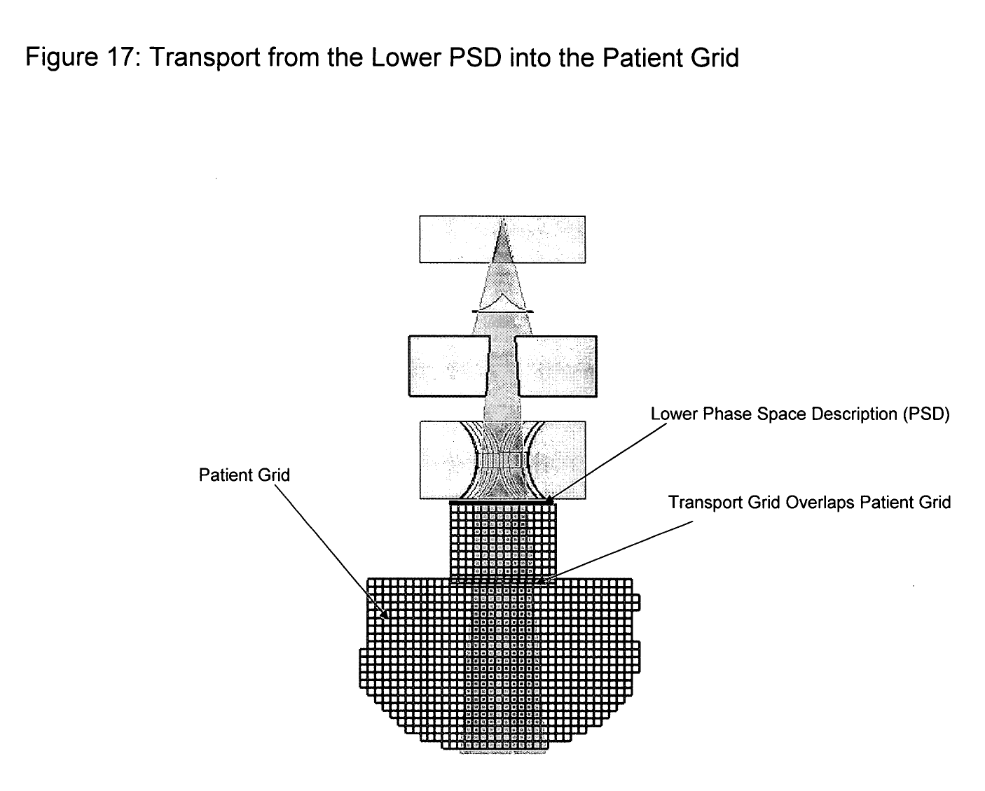

To illustrate the application of the above described methods for transporting the primary and collided fluxes into the patient anatomy, the application to IMRT is considered. The process outlined below describes one embodiment for transporting the radiation flux through field shaping devices and into the anatomical computational domain.
1. A pre-calculated PSD is defined immediately below the treatment independent components, referred to as the upper PSD (FIG. 12). In one embodiment, the PSD will be represented as a format which is directly compatible with deterministic transport solution methods, such as an analytic representation.
2. A lower PSD will be defined below the treatment dependent field shaping devices (FIG. 12). In one embodiment, the lower PSD will be located below the treatment dependent field shaping components. In another embodiment, the PSD may be located adjacent to the perimeter of the anatomical computational grid.
3. A computational grid may be used for the transport calculation through the field shaping devices, which extends from the upper PSD to the lower PSD (FIG. 13). In one embodiment, this grid is generated prior to treatment planning.
4. For each field, the following is performed:
   a. Ray tracing is performed through a surface representation of the field shaping components from to transport the primary flux from the upper PSD to the lower PSD (FIG. 14). This is repeated for the primary flux from every selected spatial location on the upper PSD. In this specific context, the primary flux may refer to the total flux (both primary and collided) at the upper PSD which is parallel, to within a specified tolerance, to the un-collided component at that spatial location. In one embodiment, ray tracing may also be performed for additional angles where only collided components exist.
   b. Ray tracing is performed through the surface representation of the field shaping components to those elements in the computational grid which fully or partially overlap one or more field shaping components (FIG. 15). Ray tracing may be performed to the centroids or unknown flux locations in each element
   c. A single collision transport calculation is performed, using a biased quadrature set, to transport the scattered radiation source to the lower PSD. More than one collision calculation may be employed if higher accuracy is desired. The radiation source to this calculation will consist of two components: (1) the volumetric first scattered source computed by the ray tracing, and (2) the boundary source consisting of the first PSD source component not transported via ray tracing.
   d. Time weighting is employed to scale the primary and scattered flux calculated at the lower PSD to reflect the specified duration for each field position.
5. The time averaged source from all fields at the lower PSD is summed, creating a single source, separately comprising primary and collided flux components for all field positions at a single gantry position.
6. In one embodiment, transport of the total flux from the second PSD into the patient computational grid is performed as follows:
   a. The process described earlier for transport of the primary flux into the computational grid is applied. In this case, each ray proceeds along a vector defined by the path from the beam source to the point in the computational grid. The flux along that direction is determined by the primary flux on the second PSD at the intersection point with the ray (FIG. 16). This process is repeated for every element in the patient grid for which ray tracing of the primary flux is desired.
   b. The scattered flux component, which is more multi-directional, can be transported into the patient through a transport calculation (possibly a single collision transport calculation) using a biased quadrature set on a computational grid (FIG. 17). Such a mesh may extend from the lower PSD to the patient grid. In one embodiment, this mesh may be adjacent to, or slightly overlap, the perimeter of the patient grid. In this embodiment, the flux from the single-collision grid will be interpolated on to the patient grid as a boundary surface source. Procedures for doing this are known to those skilled in the art. In another embodiment, single-collision grid may be topologically, or numerically, connected such that the single collision transport will be performed into the patient grid. Alternatively, a topologically connected grid may be used to provide a direct mapping of a boundary source from the transport grid to the patient grid. From this, a distributed collided source in the patient grid is obtained. The total source for the patient dose calculation is obtained by summing the distributed sources from the primary and scattered radiation. For a full treatment, the total source will be summed from each of the gantry positions, for a single patient dose calculation, with a single patient dose calculation performed for all gantry positions.

Using the principles outlined above, many alternative combinations may exist, which are too extensive to describe herein.

Last-Collided-Flux Calculation

The energy and time independent Boltzmann transport equation may be written as:
\hat{Ω}·\vec{∇}ψ(\vec{r},\hat{Ω})+σₛ(\vec{r})ψ(\vec{r},\hat{Ω})=q(\vec{r}, \hat{Ω}), (13)
where q is the scattering source plus the fixed source,

$$q ( \vec{r} , \hat{Ω} ) = {\int }_{4 π} {σ}_{s} ( \vec{r} , \hat{Ω} \cdot {\hat{Ω}}^{′} ) ψ ( \vec{r} , {\hat{Ω}}^{′} ) + s ( \vec{r} , \hat{Ω} ) , \qquad ( 14 )$$

ψ is the space and angle dependent solution vector, \vec{r} is the spatial location vector, σₜ, is the total interaction cross section, σₛ is the differential scattering cross section, and \hat{Ω} is a unit vector in the direction of particle travel. The last-collided-flux method herein provides an accurate description of the solution to the Boltzmann equation at any point, internal or external to the computational grid, by tracing along a direct line of sight back from the point in question to known source terms in the problem while accounting for absorption and scattering in the intervening media. In the case of exactly known sources and material properties, the solution is exact. This technique is a novel application of the integral form of the transport equation:

$$ψ ( \vec{r} , \hat{Ω} ) = {\int }_{0}^{R} q ( \vec{r} - {R}^{′} {Ω}^{′} , \hat{Ω} ) {ⅇ}^{- τ} + ψ ( \vec{r} - R {Ω}^{′} , \hat{Ω} ) {ⅇ}^{- τ} ⅆ {R}^{′} , \qquad ( 15 )$$

where τ, the optical path, is defined as:

$$τ = {\int }_{0}^{{R}^{′}} {σ}_{1} ( \vec{r} - {R}^{″} \hat{Ω} ) ⅆ {R}^{″} , \qquad ( 16 )$$

and R is a distance upstream from \vec{r} in the direction −\hat{Ω}. The term on the right in the integrand of Equation (15) represents the un-collided contribution to ψ at \vec{r} from the flux at point \vec{r}−R\tilde{Ω}, the upper limit of the integration path. The term on the left in the integrand represents the contribution to ψ at \vec{r} from scattering and fixed sources at all points along the integration path between 0 and R.

Equation (15) represents the angular ψ as a line integral from 0 to R upstream back along the particle flight path, \hat{Ω}. The method described herein consists of a discretized version of this line integral obtained by imposing a discrete computational mesh on the problem and evaluating the problem material properties and source terms on this mesh. The method is general and can be applied independent of the mesh type and the means of source term evaluation. The method is typically implemented as a three step process: 1) a computational mesh is created and imposed on the problem, 2) an independent calculation of unspecified nature is performed to compute the scattering sources on the mesh to some desired level of accuracy; then 3) using the mesh and scattering sources from steps one and two, a discretized version of the line integral given in equation 3 is performed to produce the solution.

As an example, a discretized implementation of Equation (15) is described using a three dimensional linear tetrahedral finite element mesh. For the source term calculation described in step two above, one embodiment is to use a discrete ordinates solver based on a linear or higher order discontinuous spatial trial space. This method in general imposes no restriction on mesh type or the means of source term calculation. Other mesh types and means of source term calculation could be employed if desired. Although energy dependence and anisotropic scattering are suppressed in this description in the interest of brevity and clarity, the method described here can easily accommodate these effects.

For the chosen mesh and spatial discretization, the source terms for the line integration are provided as linear discontinuous functions on each mesh cell and the material properties for absorption and scattering are tabulated as piecewise constant functions on each mesh cell. The line integration is performed using an analytic ray tracing technique that evaluates the line integrals by proceeding step-wise cell-by-cell through the computational mesh, accumulating the result as the process proceeds. For computational convenience, the line integral begins at the evaluation point \vec{r} and terminates at end-point R at the problem boundary. The number and direction of line integrals is arbitrary and can be specified on a per problem basis to provide the desired level of angular resolution and enhance the quality of the results. Each line integral is evaluated as the sum of contributions from individual elements that the line passes through. These elements are discovered by a simple ray tracing algorithm which computes the entering and exiting face coordinates on each tet as well the distance (δr) between these two points. Many other methods could be employed. On an individual element, the optical path (τ) is computed as the distance δr times σₜ, where σₜ is the total cross section on the element. The values of the source, which are provided at the unknown flux locations by the deterministic solver, are then interpolated to the entering and exiting face points as the weighted sum of the appropriate face vertex source values using standard finite element formulas. Given the source terms at the entering or upstream (qᵢ₊₁) and exiting or downstream (qᵢ) face points, a formula for the contribution to the line integral from the fraction of the line integral associated with any particular element can be produced by analytic evaluation of the first term in equation 3. This results in the following formula:

$$\begin{matrix}{\int }_{R}^{{R}_{i + 1}} ( . ) ⅆ R = \frac{δ r {ⅇ}^{- \sum τ}}{{t}^{2}} ( {q}_{i + 1} ( 1 - {ⅇ}^{τ} ) τ + \\ ( {q}_{i} - {q}_{i + 1} ) ( - 1 + ( 1 + τ ) {ⅇ}^{τ} ) ) ,\end{matrix} \qquad ( 16 )$$

where Στ is the total optical path from 0 to Rᵢ. For computational convenience, the path begins the integration at \vec{r} and traverses the elements in the \hat{Ω} direction out to the most distant problem boundary. The total line integral is then trivially computed as the sum of the contributions from each individual elemetn. Thus i in Equation (16) runs from zero to the number of elements in the line and Στ is the sum of all the individual τ's from R₀ to Rᵢ. If the total cross section on a cell is zero, that is τ=0, then the following formula is used in lieu of Equation (16):

$${\int }_{R}^{{R}_{i + 1}} ( . ) ⅆ R = \frac{δ r {ⅇ}^{- \sum τ}}{2} ( 3 {q}_{i + 1} - {q}_{i} ) , \qquad ( 17 )$$

where q in this case consists of simply the fixed source. At the boundary of the problem, any boundary source is accommodated by the addition of the analytic integral of the last term in Equation (15), which evaluates to:
ψ_{b}e^{-Στ}, (18)
where ψ_{b} the value of the boundary source. This procedure described above is repeated for each line integral in the problem.

For cases where the angle integrated flux is used, the analytic angular integral employs an infinite number of directions to be evaluated. In the method herein, a discretized version of the angular integral is computed as a weighted quadrature sum of all the available individual line integrals.

Ordinarily, due to run-time and memory constraints, detailed angular information is not stored in the course of most numerical transport simulations. If such information is editted, or if it results are produced with one angular resolution, then this presents a large computational workload for many numerical solvers. In general, a principle benefit of this approach is that the angular quadrature (S_{N}) order used in the deterministic transport calculation can be based on resolution of the scattering source, which may be much lower than that used to transport a radiation flux over large distances, through voids, or through streaming paths. Secondly, this approach eliminates the need to have a computational mesh extent through the air space, or void, to external points of interest. The above can result in a much faster solution speed. For some problems, memory and run-time restraints are such that normal solution techniques at a desired resolution are completely impractical, and the method described herein becomes an enabling technology.

This method is useful in a broad range of applications including, but not limited to: (1) transporting the radiation flux to detectors for image reconstruction, (2) resolving streaming paths for shielding calculations, (3) transporting an adjoint scattering source back to a prescribed PSD for radiotherapy dose calculations, and (4) calculating the angular flux distribution at any point or surface for angles other than those solved for in a discrete-ordinates transport calculation.

Use of the Last-Collided-Flux Method for Image Reconstruction

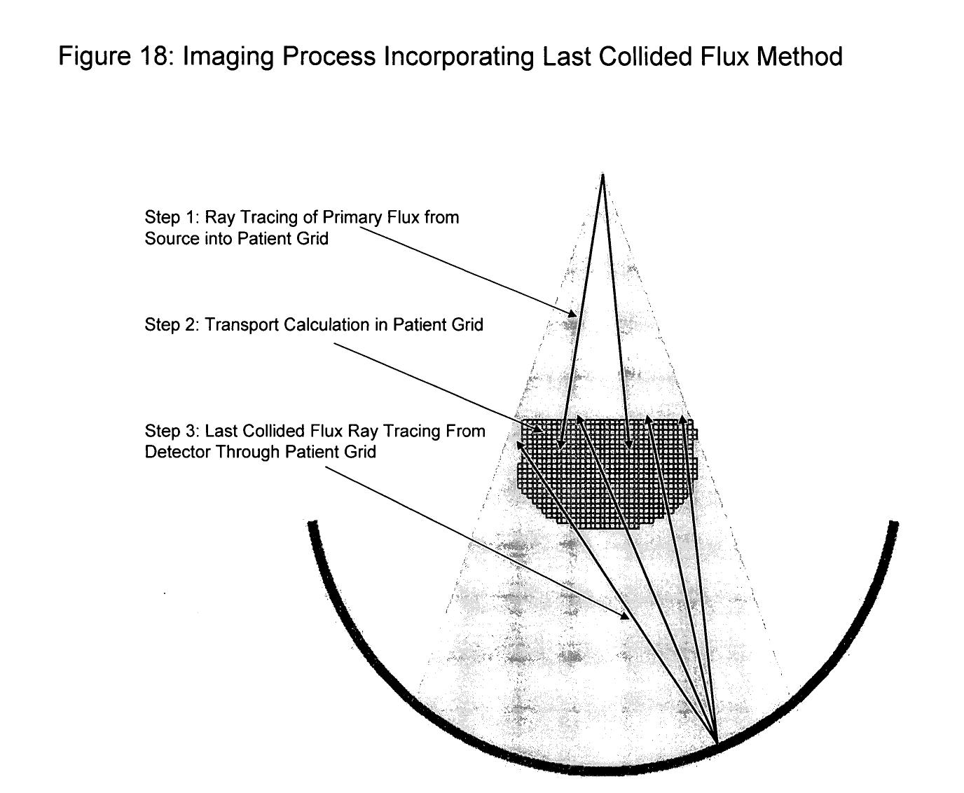

For image reconstruction, this method can be used to efficiently and accurately calculate the angular and energy dependent flux incident on detectors far away from the imaged volume. In this embodiment, the primary flux is analytically transported into the patient grid via ray tracing (FIG. 18). An S_{N} (discrete ordinates) transport calculation then solves for transport solution in the patient grid. The patient grid transport solution is then transported to the detectors through application of the last-collided-flux method, where ray tracing is performed from each detector where the scattered flux is desired, through the patient grid at prescribed vectors. For each detector, the vectors for which the last-collided-flux is computed may be varied, to account for the detector specific orientation and collimation, and may be different for each detector.

For emission computed tomography modalities, such as SPECT or PET, a single transport calculation may be performed on the patient grid, with the last-collided-flux method used to subsequently transport the scattered radiation source to external detector locations.

Adjoint Calculations for Calculating Detector Response

The last-collied-flux method, described above, provides an efficient means for transporting the angular and energy dependent flux to external locations such as detectors. This approach can be coupled with an adjoint solution method to characterize a specific detector response resulting from an angular and energy dependent flux incident at any point located at, or immediately above, the collimator entrances. Although typical imaging detector arrays may comprise thousands of detectors, for a specific detector of interest, detector V, only the flux incident on the collimator entrance of detector V, and detectors in near proximity, will provide a measurable response in detector V. Since imaging detector arrays are typically arranged in regular arrays, many detectors may have the response characteristics as detector V, and thus an entire detector array may often be characterized by performing a handful of adjoint calculations, one performed for each unique detector arrangement.

This approach can be beneficial for imaging system design applications, where it may be desirable to rapidly test the responses for various collimator arrangements. This may also be beneficial for clinical applications employing adaptive collimators for which it may not be possible to accurately determine detector responses in advance.

In one embodiment, a calculation is then performed to characterize the response in a detector by constructing a computational grid comprising the detector-collimator pack including the detector of interest, detector V, and neighboring detectors and collimators which may influence the response in detector V. The KERMA cross section may be specified as the source in detector V, and then the adjoint form of the radiation transport equation is solved, either stochastically or deterministically. This will solve for the importance map (adjoint flux), which provides the contribution of an angular and energy dependent flux at any location in the computational domain to the KERMA reaction rate (energy deposition rate) in detector V. Given the adjoint solution, the KERMA reaction rate, R, in a detector, V, from any external surface source can be determined using the following equation:
R=∫dA∫dE∫_{\hat{n}·\hat{Ω}<0}d\hat{Ω}|\hat{n}·\hat{Ω}|ψ*ψ, (19)
Here ψ* is the adjoint angular flux and ψ is the known incoming angular flux on the surface (A). For most collimated detector arrays, ψ* will be negligible on all surfaces except for the entrances to the collimators directly above detector V and adjacent detectors. Thus the adjoint calculation will need to be done only once for each detector configuration. ψ on the incoming surfaces can be calculated from the forward calculation, perhaps using the above last-collided-flux method. In one embodiment, the last-collided-flux method may be used for both ψ* and ψ, using the same quadrature angles and weights so that the above equation can be directly solved. ψ* may be calculated for a specified set of points on the surface A where ψ* is known to be sufficiently large so that there is a contribution to R.
Adjoint Calculations for Treatment Planning

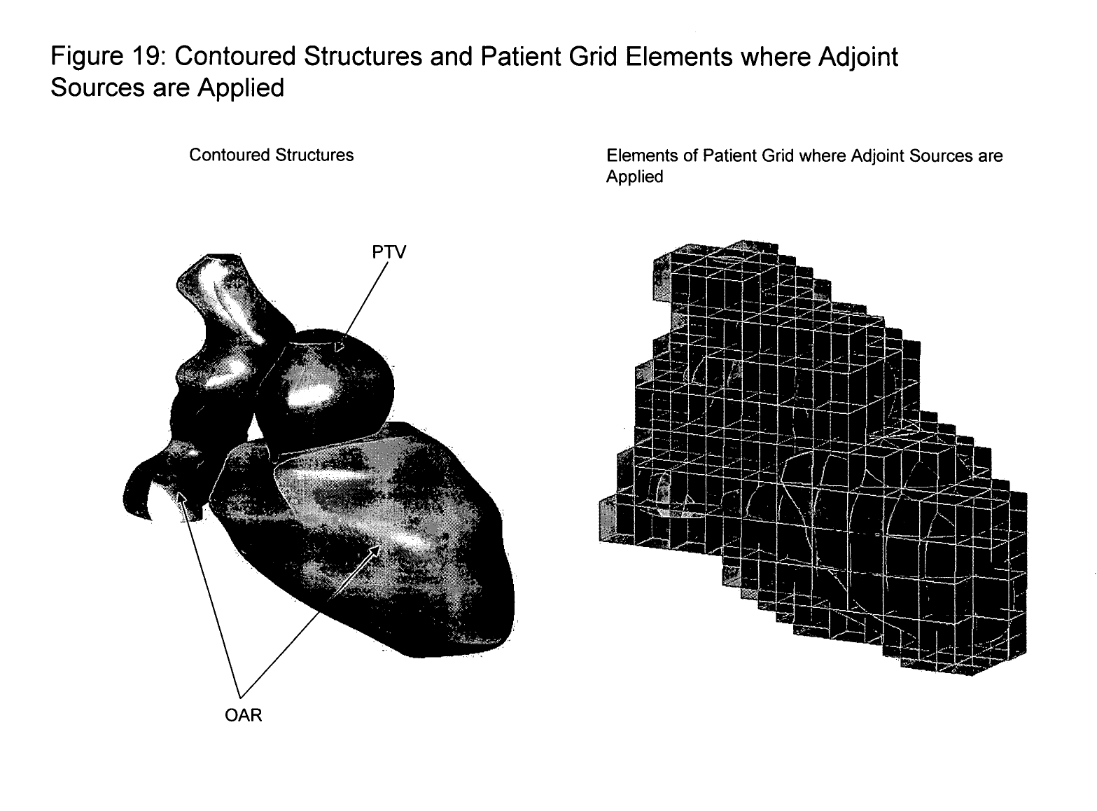

For radiotherapy treatment planning, one embodiment is to solve the adjoint form of the transport euqations to calculate for the importance flux (contribution) from every location within the patient grid, to the dose in regions of interest. In this manner, the regions where the dose is of interest (planning treatment volume, critical structures, etc.) are represented as a collection of discrete source regions, where each source may correspond to one or more elements in the patient grid (FIG. 19). A separate adjoint calculation is then performed for each discrete source region, which calculates the importance flux solution throughout the patient grid.

One embodiment is to use an energy dependent flux-to-dose conversion factor as the spectrum for the adjoint source. For each specified adjoint source region, the adjoint form of the transport equations is solved for on the patient grid, which solves for the dose contribution to the adjoint source region from the angular and energy dependent particle flux at every spatial degree of freedom in the patient grid. This approach is valid for both single and coupled particle type simulations. For example, in photon beam radiotherapy where electron transport is explicitly solved for, an electron adjoint source will be applied, and secondary photons are generated in the adjoint simulation.

This approach may employ many of the techniques described earlier for creating primary and secondary patient grids, material mapping, adaptation, and other approaches described herein.

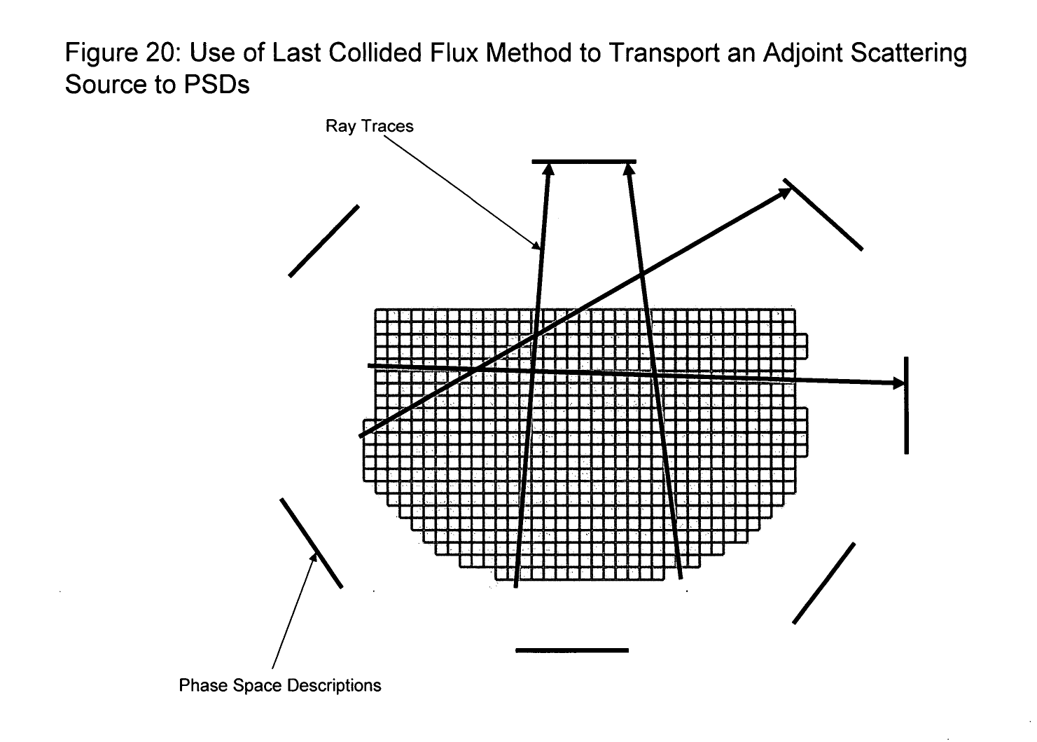

In one embodiment, the last-collided-flux method, described previously, will be used to transport the adjoint scattering source in the patient grid, computed by solving the adjoint form of the transport equations, to points external to the patient grid where the treatment parameters are specified, such as at a PSD below the field shaping devices (FIG. 20). In one embodiment, for photon beam radiotherapy the adjoint scattering source is comprised only of photons.

In one embodiment, a set of adjoint calculations will be performed after initial contouring of the acquired image by a physician (Radiation Oncologist) to delineate treatment volumes and critical structures, but prior to treatment planning (performed by a Medical Physicist). This may comprise a large number of calculations, since a separate calculation may be performed for each patient grid element where the dose is of clinical interest. However, since these calculations can be performed off-line and prior to treatment planning, computational times are not as critical a consideration, especially when parallel processing or other acceleration techniques are employed.

When completed, the set of adjoint calculations can be used to reconstruct the dose field resulting from a particle flux at any location in the patient grid, as a function of angle and energy. In this manner, the adjoint calculations are completely independent of any selected treatment plan, and may be performed prior to any treatment planning.

During treatment planning, detailed patient dose distributions can then be rapidly obtained for a prescribed treatment by applying the last-collided-flux method, described earlier, to transport the adjoint scattering source from the patient grid to locations where the treatment plan is prescribed, such as at a PSD below the field shaping devices (FIG. 20). Each ray trace calculates a dose response in the patient grid for a specified angular and energy dependent flux originating at a specific location on the PSD.

In such a manner, ray tracing will be performed for a sufficient number of points on the PSD, at prescribed angles, through the patient grid. The dose distribution resulting from each ray is obtained by summing the dose contribution to each discrete source region used in the set of adjoint calculations previously performed.

Many embodiments of this approach may exist, such as the techniques described earlier for transporting a primary radiation source through field shaping devices. For example, the adjoint form of the last-collided-flux method can be used to transport the adjoint scattering source through field shaping devices and back at point where the treatment plan is specified.

A major benefit of the above approach is that, by solving the adjoint solution matrix to sufficient detail, it can eliminate the need to perform transport calculations on the patient anatomy during treatment planning. As an example, parameters governing the adjoint calculation matrix include the patient anatomy, source spectrum, and particle types to be solved. Thus, the adjoint calculation matrix is completely independent of beam delivery parameters such as the number of beams, orientation, field sizes, etc. During treatment planning, only the last-collided-flux calculation will need to be peformed to ray trace the calculated adjoint source to points external to the computational mesh which are specified as in the treatment plan.

Various elements in the process for performing the above are outlined below. In general, many of the processes and principles described earlier for forward calculations are directly applicable to adjoint calculations, and thus, are not repeated in detail here.
1. In certain cases, the primary flux from the adjoint source may be transported through ray tracing, similar to methods described herein.
2. For photon beam radiotherapy, electrons may be transported on a subset of the full patient grid, where elements existing beyond a threshhold optical distance from the source may be suppressed. In one embodiment, this can be determined by calculating the optical distance by tracing from the centroid of the adjoint source element to the centroids of neighboring elements.
3. The adjoint photon source, produced by the adjoint electron transport, will be present in only those elements used in the electron transport calculation. Photon transport may be performed on the full patient grid, including those elements suppressed in the electron transport. In an alternative embodiment, electron and photon transport may be performed on separate grids, using different element sizes or topologies.
4. A variety of software and hardware acceleration techniques, such as parallel processing, may be employed to accelerate the computation of the full adjoint matrix.
5. To minimize reconstruction times, the data produced by the matrix of adjoint calculations may be reprocessed into a format which can be rapidly accessed for dose reconstruction during treatment planning. A variety of techniques may be employed to condense the adjoint matrix for storage and subsequent access time during treatment planning. As an example, dose contributions of specific angular, spatial and energy dependent fluxes that are below a defined threshhold may be zeroed out and eliminated from the storage matrix. Many different techniques may be applied, which are too numerous to describe herein.
6. In one embodiment, the data used from the adjoint calculations for reconstruction will be read into memory prior to commencement of treatment planning.
7. The development of a single optimized treatment plan may employ hundreds of dose calculations to be performed. Using the precalculated adjoint solution matrix, the patient dose at each treatment plan iteration can be rapidly determined as follows:
   a. The treatment plan may be defined at a PSD below the field shaping devices (or beam source (target)). In general, treatments may include multiple beams, with a separate PSD or beam target existing for each beam. If defined at a PSD, a 2-D spatial distribution of the angular and energy dependent flux will be provided. If defined at the target, the source can be represented as a single point, for which the energy dependent flux is dependent only on angle. In both cases, the spatial or angular distribution may be represented using a variety of methods.
   b. A spatial and angular discretization is selected for which the last-collided-flux calculation will be performed. For a PSD based specificiation, the treatment plan can be represented by a 2-D grid, where the energy dependent flux at each grid element is prescribed for a number of angles. The angles for which the last-collided-flux calculation is performed may be different for each grid element. For a target based specification, the treatment plan may also be represented as a 2-D grid, similar to a PSD. However, only a single angle may be prescribed for each grid point. Combinations of PSD and target based treatments may also be employed.
   c. For each selected angle at every spatial location, the last-collided-flux calculation will be performed by ray tracing from the PSD, or target, through the computational grid. To preserve maximum spatial resolution, the optical depth calculated in the ray tracing may be calculated on a finer resolution grid, such as the raw acquired image data or an alternative voxel representation, than that used in the transport calculations.
   d. To reconstruct the dose at all adjoint sources from a flux originating at a specific point, angle, and energy spectrum, it is necessary to calculate the contribution to each adjoint source for every element the ray passes through. In this manner, a single ray trace only needs to be performed for a flux originating at a specific point, angle and energy spectrum, and a separate ray trace does not need to be performed for separate adjoint source.

The above mentioned process provides a way to efficiently perform highly accurate dose calculations during the radiotherapy treatment planning process. Alternative embodiments exist, such as using the last-collided-flux to tranport the adjoint solution out to a circumferential grid of points around the patient perimeter, which be used to optimize selected beam angles. In different embodiments, it may be useful to specify whole regions, such as the PTV, OAR, and other critical structures, as single adjoint sources.

Brachytherapy Specific Approaches

Many of the techniques described above can also be applied, in one embodiment or another, to brachytherapy dose calculations. In addition, other specific methods applicable to brachytherapy are described below.

The single collision calculation method, described earlier, may be used to transport the primary flux from multiple brachytherapy sources using a high S_{N} order, with the subsequent transport calculation being performed with a lower S_{N} order. In one embodiment, only the dominant energy groups may be transported through this method, even though more groups are used in the transport calculation. Using a single collision calculation to transport the primary flux can be beneficial when a large number of source are present, such as in prostate brachytherapy. In such cases, ray tracing for all of the primary sources may be time consuming.

This technique can also be applied to transport the primary flux for many shielding applications.

For delivery modes such as high dose rate (HDR) and pulsed dose rate (PDR) brachytherapy, a single source may be attached to a cable, where its position is incrementally adjusted during the course of a treatment. Since a treatment may include numerous source positions, one may be to perform a single dose calculation which includes all source positions. However, a complication may be introduced by explicitly modeling all sources simultaneously in a single calculation. Specifically, inter-source shielding may cause attenuations that are not physically present in the patient treatment. Methods for mitigating inter-source attenuation may be performed. One embodiment is for the primary source to be transported, either via ray tracing, with the material properties of neighboring source positions modeled as air, or an appropriate background medium. This process is then repeated for ray tracing from each source. The subsequent transport calculation may then be performed with all source materials explicitly modeled.

What is claimed is:

1. A method for calculating scattered radiation for the purposes of image reconstruction for computed tomography, the method comprising a three part process:
transporting a primary radiation source, via ray tracing, at a first resolution into a computational grid comprising an acquired image volume, for determining the source for a radiation transport calculation;
performing a deterministic radiation transport calculation at a second, coarser resolution than the first resolution to calculate the scattering source; and
transporting the scattered radiation source to detectors using a ray-tracing based last-collided-flux method.

2. A method for calculating scattered radiation for the purposes of image reconstruction for imaging methods such as positron emission tomography and single photon emission computed tomography, the method comprising a two part process:
performing a deterministic radiation transport calculation to calculate the scattering source; and
transporting the scattered radiation source to detectors using a ray-tracing based last-collided-flux method.

3. A method for calculating delivered doses from external photon beam radiotherapy treatments, the method comprising:
transporting a primary radiation source, via ray tracing, at a first resolution into a computational grid comprising an acquired image volume, for determining the primary source for a radiation transport calculation;
transporting the scattered radiation source, deterministically, into the computational grid comprising an acquired image volume, for determining the scattered source for a radiation transport calculation; and
performing a deterministic coupled photon-electron radiation transport calculation, using the primary and scattered radiation sources from the incident beam, to calculate the delivered dose.

4. A method for performing fast dose calculations, the method comprising:
performing deterministic calculations using the adjoint form of radiation transport equations, prior to treatment planning, to calculate the energy and angle-dependent flux at each unknown flux location in a computational grid superimposed on an acquired image representation of the patient anatomy;
performing a separate adjoint calculation for each spatial location where the dose is of interest;
performing a ray-tracing-based last-collided-flux method to transport the adjoint scattering source from the computational grid to a location where the treatment plan is specified to determine the patient dose response for a flux at a specific location, angle and energy prescribed in a treatment plan; and
reconstructing the patient dose field by repeating the above ray-tracing for each angle, energy and spatial location necessary to sufficiently define the desired treatment plan.
